(19) United States
(12) Patent Application Publication
(10) Pub. No.: US 2022/0282079 A1
(43) Pub. Date: Sep. 8, 2022

(54) Composition and Article Including Fluoropolymer and Branched Silsesquioxane Polymer

(71) Applicant: 3M INNOVATIVE PROPERTIES COMPANY, St. Paul, MN (US)

(72) Inventors: Michael H. Mitchell, Edina, MN (US); Chetan P. Jariwala, Woodbury, MN (US); Jitendra S. Rathore, Woodbury, MN (US); Tho Q. Nguyen, Bloomington, MN (US)

(21) Appl. No.: 17/632,253

(22) PCT Filed: Sep. 3, 2020
(86) PCT No.: PCT/US2020/049273

§ 371 Date: Feb. 2, 2022

Related U.S. Application Data
(60) Provisional application No. 62/896,069, filed on Sep. 5, 2019.

(51) Int. Cl. C08L 27/24; C08L 27/18; C08L 27/20; C08L 27/16; C08L 29/10

(52) U.S. Cl. CPC C08L 27/24; C08L 27/18; C08L 27/20; C08L 27/16; C08L 29/10; C08L 2312/00

(57) ABSTRACT

The composition can include a fluoropolymer and a branched silsesquioxane polymer having terminal —Si(R³)₃ groups and units having formula, in which * represents a bond to another silicon atom in the branched silsesquioxane polymer, R is an organic group comprising an aliphatic carbon-carbon double bond, and R³ is a non-hydrolyzable group or hydrogen. The fluoropolymer can be crosslinked with the branched silsesquioxane polymer. An article can include a first composition including a fluoropolymer in contact with a second composition including a silicone, wherein at least one of the first composition or second composition includes the branched silsesquioxane polymer. At least one of the fluoropolymer or the silicone can be crosslinked with a branched silsesquioxane polymer including terminal —Si(R³)₃ groups and units having formula, in which R* is an organic group comprising a carbon-carbon bond between the branched silsesquioxane polymer and the fluoropolymer, the silicone, or another R* group.

### BACKGROUND

Fluoroelastomers are known to have excellent mechanical properties, heat resistance, weather resistance, and chemical resistance, for example. Such beneficial properties render fluoroelastomers useful for example, as O-rings, seals, hoses, skid materials, and coatings (e.g., metal gasket coating for automobiles). Fluoroelastomers have been found useful in the automotive, chemical processing, semiconductor, aerospace, and petroleum industries, among others.

Fluoroelastomers are typically prepared by combining an amorphous fluoropolymer, sometimes referred to as a fluoroelastomer gum, with one or more curatives, shaping the resulting curable composition into a desired shape, and curing the curable composition. The amorphous fluoropolymer often includes a cure site, which is a functional group incorporated into the amorphous fluoropolymer backbone capable of reacting with a certain curative.

Certain reactive silicon-containing compounds have been added to curable fluoropolymer compounds. See, for example, U.S. Pat. Appl. Pub. No 2017/0263908 (Laicer et al.) and Int. Pat. Appl. Pub. No. WO 2019/133410 (Mitchell et al.).

### SUMMARY

The present disclosure provides compositions and articles that include a fluoropolymer that can include or is at least partially crosslinked with a branched silsesquioxane polymer. Typically, when the branched silsesquioxane polymer is used to crosslink a fluoropolymer to make a fluorolastomer, the tear resistance of the fluoroelastomer is higher than when a comparative fluoroelastomer is made in the absence of the branched silsesquioxane polymer. Typically and unexpectedly, fluoroelastomers crosslinked with the branched silsesquioxane polymer have much lower compression set than fluoroealstomers crosslinked with polysiloxanes including aliphatic carbon-carbon double bonds.

In one aspect, the present disclosure provides a composition that includes a fluoropolymer and a branched silsesquioxane polymer having terminal —Si(R³)₃ groups and units represented by formula:

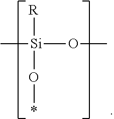

In this formula, * represents a bond to another silicon atom in the branched silsesquioxane polymer, each R is independently an organic group including an aliphatic carbon-carbon double bond, and each R³ is independently a non-hydrolyzable group with the proviso that one R³ may be hydrogen.

In another aspect, the present disclosure provides an article that includes a first composition including a fluoropolymer in contact with a second composition including a silicone. At least one of the first composition or second composition includes a branched silsesquioxane polymer having terminal —Si(R³)₃ groups and units represented by formula:

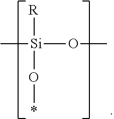

In this formula, * represents a bond to another silicon atom in the branched silsesquioxane polymer, each R is independently an organic group including an aliphatic carbon-carbon double bond, and each R³ is independently a non-hydrolyzable group with the proviso that one R³ may be hydrogen.

In another aspect, the present disclosure provides article including a fluoropolymer crosslinked with a branched silsesquioxane polymer having terminal —Si(R³)₃ groups and units represented by formula:

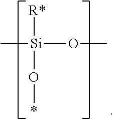

In this formula, * represents a bond to another silicon atom in the branched silsesquioxane polymer, each R* is independently an organic group including a carbon-carbon bond between the branched silsesquioxane polymer and the fluoropolymer or another R* group in the branched silsesquioxane polymer, and each R³ is independently a non-hydrolyzable group with the proviso that one R³ may be hydrogen.

In another aspect, the present disclosure provides an article including a fluoropolymer in contact with a silicone. At least one of the fluoropolymer or the silicone is crosslinked with a branched silsesquioxane polymer having terminal —Si(R³)₃ groups and units represented by formula:

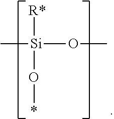

In this formula, * represents a bond to another silicon atom in the branched silsesquioxane polymer, each R* is independently an organic group including a carbon-carbon bond between the branched silsesquioxane polymer and the fluoropolymer, the silicone, or another R* group in the branched silsesquioxane polymer, and each R³ is independently a non-hydrolyzable group with the proviso that one R³ may be hydrogen.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The term “aliphatic” refers to being non-aromatic. This term is used to encompass alkyl, alkenyl, and alkynyl groups, for example.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Cyclic groups can be monocyclic or polycyclic and typically have from 3 to 10 ring carbon atoms. Examples of “alkyl” groups include methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, and norbornyl.

The term “alkylene” is the divalent or trivalent form of the “alkyl” groups defined above.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms and optionally contain at least one heteroatom (i.e., O, N, or S). In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, anthracyl, and pyridinyl.

The term “arylene” is the divalent form of the “aryl” groups defined above.

The terms “cure” and “curable” joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility but may be swellable in the presence of an appropriate solvent.

The term “catenated heteroatom” means an atom other than carbon (for example, oxygen, nitrogen, or sulfur) that replaces one or more carbon atoms in a carbon chain (for example, so as to form a carbon-heteroatom-carbon chain or a carbon-heteroatom-heteroatom-carbon chain).

The phrase “interrupted by at least one —O— group”, for example, with regard to a perfluoroalkyl or perfluoroalkylene group refers to having part of the perfluoroalkyl or perfluoroalkylene on both sides of the —O— group. For example, —CF₂CF₂—O—CF₂—CF₂— is a perfluoroalkylene group interrupted by an —O—.

The term “(meth)acrylate group” is a functional group that refers to an acrylate group of the formula CH₂═CH—C(O)O— and a methacrylate group of the formula CH₂═C(CH₃)—C(O)O—.

The term “halogen” refers to a halogen atom or one or more halogen atoms, including chlorine, bromine, iodine, and fluorine atoms or fluoro, chloro, bromo, or iodo substituents.

The term “fluoro-” (for example, in reference to a group or moiety, such as in the case of “fluoroalkylene” or “fluoroalkyl” or “fluorocarbon”) or “fluorinated” can mean partially fluorinated such that there is at least one carbon-bonded hydrogen atom or perfluorinated.

The term “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

The term “perfluoroether” means a group or moiety having two saturated or unsaturated perfluorocarbon groups (linear, branched, cyclic (preferably, alicyclic), or a combination thereof) linked with an oxygen atom (that is, there is at least one catenated oxygen atom).

The term “polyfluoropolyether” means a group having three or more saturated or unsaturated perfluorocarbon groups (linear, branched, cyclic (preferably, alicyclic), or a combination thereof) linked with oxygen atoms (that is, there are at least two catenated oxygen atoms).

A silsesquioxane is an organosilicon compound with the empirical chemical formula R′SiO3/2 where Si is the element silicon, O is oxygen and R′ is either hydrogen or an aliphatic or aromatic organic group that optionally further comprises an ethylenically unsaturated group. Thus, silsesquioxanes polymers comprise silicon atoms bonded to three oxygen atoms. Silsesquioxanes polymers that have a random branched structure are typically liquids at room temperature. Silsesquioxanes polymers that have a non-random structure like cubes, hexagonal prisms, octagonal prisms, decagonal prisms, and dodecagonal prisms are typically solids as room temperature. The branched silsesquioxane polymers in the compositions and articles of the present disclosure exclude cage structures (e.g., cubes, hexagonal prisms, octagonal prisms, decagonal prisms, and dodecagonal prisms).

All numerical ranges are inclusive of their endpoints and nonintegral values between the endpoints unless otherwise stated (e.g., 1 to 5 includes 1, 1.5, 2, 2.75, 3, 3.80, 4, 5, etc.).

### BRIEF DESCRIPTION OF THE DRAWINGS

FIG. 1 is a depiction of the structure of an embodiment of the branched silsesquioxane polymer useful in the compositions and articles of the present disclosure.

FIG. 2 is a schematic side view of an embodiment of an article of the present disclosure.

FIG. 3 is a perspective side of another embodiment of an article of the present disclosure.

### DETAILED DESCRIPTION

The branched silsesquioxane polymer useful in the compositions and articles of the present disclosure includes terminal —Si(R³)₃ groups and units represented by formula

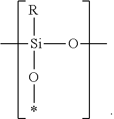

In this formula, * represents a bond to another silicon atom in the branched silsesquioxane polymer, and each R is independently an organic group comprising an aliphatic carbon-carbon double bond. Each R³ in the terminal groups is independently a non-hydrolyzable group with the proviso that one R³ may be hydrogen.

In some embodiments, each R is independently represented by —Y—Z, wherein Y is a bond, alkylene, arylene, or alkylene at least one of interrupted or terminated by arylene, wherein alkylene and alkylene at least one of interrupted or terminated by arylene are unsubstituted or substituted with halogen and optionally interrupted by at least one catenated —O—, —NR′—, —S—, —Si—, or combination thereof, and wherein arylene is unsubstituted or substituted by at least one alkyl, alkoxy, halogen, or combination thereof, wherein R′ is hydrogen or alkyl having up to four carbon atoms. In some embodiments, Y is a bond, an alkylene group having from 1 to 20, 1 to 6, 1 to 4, 1 to 3, 1 to 2, or 1 carbon atom, phenylene, or an alkylene group having from 1 to 6, 1 to 4, or 1 to 3 carbon atoms interrupted by phenylene (e.g., methylphenylpropyl). In formula —Y—Z, Z is vinyl (i.e., —CH═CH₂), vinyl ether (i.e., —O—CH═CH₂), acryloyloxy (i.e., —O—C(O)—CH═CH₂), methacryloyloxy (i.e., —O—C(O)—C(CH₃)═CH₂), acryloylamino (i.e., —NR′—C(O)—CH═CH₂ wherein R′ is hydrogen or alkyl having up to four carbon atoms), or methacryloylamino group (i.e., —NR′—C(O)—C(CH₃)═CH₂, wherein R′ is hydrogen or alkyl having up to four carbon atoms). When Y is alkylene and Z is a vinyl group, Y-Z is an alkenyl group. Such alkenyl group may have the formula (H₂C═CH(CH₂)_{y}— wherein y is 1 to 20, 1 to 6, 1 to 4, 1 to 3, 1 to 2, or 1). The alkylene group can be 3-butenyl, docosenyl, or hexenyl, for example. In some embodiments, —Y—Z is allyl (i.e., —CH₂—CH═CH₂).

Fluoropolymers and/or silicones described in further detail below can be crosslinked with the branched silsesquioxane polymer, and the resulting network can have units represented by formula

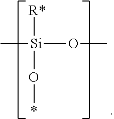

In this formula, * represents a bond to another silicon atom in the branched silsesquioxane polymer; and each R* is independently an organic group comprising a carbon-carbon bond between the branched silsesquioxane polymer and the fluoropolymer, silicone, or another R* group in the branched silsesquioxane polymer. Upon crosslinking, in the R group in the branched silsesquioxane polymer, described above, the aliphatic carbon-carbon double bond reacts to form the R* group. In embodiments in which the R group is represented by —Y—Z, R* may consist of the carbon-carbon bond between the branched silsesquioxane polymer and the fluoropolymer, silicon, or another R* group, or R* can optionally further include alkylene, arylene, or alkylene at least one of interrupted or terminated by arylene, —O—, —NR′—, —O—C(O)—, —NR′—C(O)—, —S—, —Si—, or a combination thereof, wherein R′ is hydrogen or alkyl having up to four carbon atoms, and optionally substituted by halogen and, in the case of arylene, optionally substituted by alkyl or alkoxy. In some embodiments, R* is the carbon-carbon bond optionally bonded to —(CH₂)_{y}—, wherein y is 1 to 6, 1 to 4, 1 to 3, 1 to 2, or 1.

In some embodiments, the branched silsesquioxane polymer useful in the compositions and articles of the present disclosure includes units represented by formula:

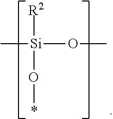

In this formula, * represents a bond to another silicon atom in the branched silsesquioxane polymer, and each R² is independently a hydrogen or non-hydrolyzable group not comprising an aliphatic carbon-carbon double bond. As stated above, each R³ in the terminal groups is independently a non-hydrolyzable group with the proviso that one R³ may be hydrogen.

Suitable non-hydrolyzable groups useful as R² and R³ substituents include alkyl, aryl, alkylene at least one of interrupted or terminated by arylene or heterocyclylene, wherein alkyl and alkylene at least one of interrupted or terminated by arylene or heterocyclylene are unsubstituted or substituted with halogen and optionally interrupted by at least one catenated —O—, —NR′—, —S—, —Si—, or combination thereof, and wherein aryl, arylene, and heterocyclylene are unsubstituted or substituted by at least one alkyl, alkoxy, halogen, or combination thereof. R² and R³ non-hydrolyzable groups are selected independently from each other.

In some embodiments, the halogen or halogens on the alkyl, alkylene, arylene, or heterocyclylene group is fluoro. When at least one of R² or R³ is fluorinated, in some embodiments, at least one of R² or R³ is R_{f}CⱼH₂ⱼ—, wherein j is 2 to 8 (or 2 to 3), and R_{f} is a fluorinated or perfluorinated alkyl group having 1 to 12 carbon atoms (or 1 to 6 carbon atoms); in some embodiments, at least one of R² or R³ is R_{f}′CⱼH₂ⱼ—, wherein j is 2 to 8 (or 2 to 3), and R_{f}′ is a fluorinated or perfluorinated polyether group having 1 to 45 carbon atoms (in some embodiments, 1 to 30 carbon atoms). Perfluoropolyether groups that can be linear, branched, cyclic, or a combination thereof. The perfluoropolyether group can be saturated or unsaturated (in some embodiments, saturated). Examples of useful perfluoropolyether groups include those that have —(CₚF₂ₚ)—, —(CₚF₂ₚO)—, —(CF(RF)O)—, —(CF(RF)CₚF₂ₚO)—, —(CₚF₂ₚCF(RF)O)—, or —(CF₂CF(RF)O)— repeating units or combinations thereof, wherein p is an integer of 1 to 10 (or 1 to 8, or 1 to 6, or 1 to 4, or 1 to 3); RF is selected from perfluoroalkyl, perfluoroether, perfluoropolyether, and perfluoroalkoxy groups that are linear, branched, cyclic, or a combination thereof and that have up to 12 carbon atoms, up to 10 carbon atoms, up to 8 carbon atoms, up to 6 carbon atoms, up to 4 carbon atoms, or up to 3 carbon atoms) and/or up to 4 oxygen atoms, up to 3 oxygen atoms, up to 2 oxygen atoms, or zero or one oxygen atom. In these perfluoropolyether structures, different repeating units can be combined in a block, alternating, or random arrangement to form the perfluoropolyether group. The terminal group of the perfluoropolyether group can be (CₚF₂ₚ₊₁)— or (CₚF₂ₚ₊₁O)—, for example, wherein p is as defined above. Examples of useful perfluoropolyether groups include C₃F₇O(CF(CF₃)CF₂O)ₙ—CF(CF₃)—, C₃F₇O(CF₂CF₂CF₂O)—CF₂CF₂—, CF₃O(C₂F₄O)ₙ—CF₂—, CF₃O(CF₂O)ₙ—C₂F₄O)_{q}CF₂—, and F(CF₂)₃O(C₃F₆O)_{q}(CF₂)₃—, wherein n″ has an average value of 0 to 50, or 1 to 50, or 3 to 30, or 3 to 15, or 3 to 10; and q has an average value of 0 to 50, or 3 to 30, or 3 to 15, or 3 to 10. In some embodiments, the perfluoropolyether group comprises at least one divalent hexafluoropropyleneoxy group (—CF(CF₃)—CF₂O—). Perfluoropolyether groups can include F[CF(CF₃)CF₂O]ₐCF(CF₃)— (or, as represented above, C₃F₇O(CF(CF₃)CF₂O)ₙ—CF(CF₃), where n″+1=a), wherein a has an average value of 4 to 20. Such perfluoropolyether groups can be obtained through the oligomerization of hexafluoropropylene oxide.

In some embodiments, each R³ is independently hydrogen, alkyl, aryl, or alkyl substituted by fluoro and optionally interrupted by at least one catenated —O— group. Typically, only one R³ is hydrogen. Suitable alkyl groups for R³ typically have 1 to 20, 1 to 18, 1 to 12, 1 to 10, 1 to 6, or 1 to 4 carbon atoms. Examples of useful alkyl groups include methyl, ethyl, isopropyl, n-propyl, n-butyl, and iso-butyl. In some embodiments, each R³ is independently alkyl having up to six (in some embodiments, up to 4, 3, or 2) carbon atoms, F[CF(CF₃)CF₂O]ₐCF(CF₃)CⱼH₂ⱼ— (wherein j 2 to 8 (or 2 to 3) and a has an average value of 4 to 20), C₄F₉C₃H₆—, C₄F₉C₂H₄—, C₄F₉OC₃H₆—, C₆F₁₃C₃H₆—, C₆F₁₃C₂H₄—, CF₃C₃H₆—, CF₃C₂H₄—, phenyl, benzyl, or C₆H₅C₂H₄—. In some embodiments, each R³ is independently methyl or phenyl. In some embodiments, each R³ is methyl.

In some embodiments, each R² is independently hydrogen, alkyl, aryl, or alkyl substituted by fluoro and optionally interrupted by at least one catenated —O— group. Suitable alkyl groups for R² typically have 1 to 20, 1 to 18, 1 to 12, 1 to 10, 1 to 6, or 1 to 4 carbon atoms. Examples of useful alkyl groups include methyl, ethyl, isopropyl, n-propyl, n-butyl, iso-butyl, and octadecyl. In some embodiments, each R² is independently alkyl having up to 18 (in some embodiments, up to 4, 3, or 2) carbon atoms, F[CF(CF₃)CF₂O]ₐCF(CF₃)CⱼH₂ⱼ— (wherein j is 2 to 8 (or 2 to 3) and a has an average value of 4 to 20), C₄F₉C₃H₆—, C₄F₉C₂H₄—, C₄F₉OC₃H₆—, C₆F₁₃C₃H₃—, C₆F₁₃C₂H₄—, CF₃C₃H₆—, CF₃C₂H₄—, phenyl, benzyl, or C₆H₅C₂H₄—. In some embodiments, each R² is independently methyl, phenyl, C₆F₁₃C₂H₄—, or octadecyl.

In some embodiments, the branched silsesquioxane polymer useful in the compositions and articles of the present disclosure is represented by formula:

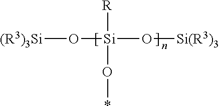

wherein *, R, and R³ are independently as defined above in any of their embodiments, and wherein n is at least 2. In some embodiments, n is at least 3, 4, 5, 6, 7, 8 or 9.

In some embodiments, the branched silsesquioxane polymer useful in the compositions and articles of the present disclosure is represented by formula:

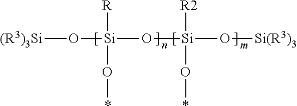

wherein *, R, R², and R³ are independently as defined above in any of their embodiments, and n+m is greater than 3. Although this formula is shown as a block copolymer, it should be understood that the divalent units including R and R² can be randomly positioned in the copolymer. Thus, branched silsesquioxane polymers useful for practicing the present disclosure also include random copolymers. In some embodiments, m is at least 1, 2, 3, 4, 5, 6, 7, 8, 9 and the sum of n+m is 3 or greater than 3. In some embodiments, n, m, or n+m is at least 10, 15, 20, 25, 30, 35, 40, 45, or 50. In some embodiments, n or m is not more than 500, 450, 400, 350, 300, 250, or 200. Thus, n+m can range up to 1000. In some embodiments, n+m is an integer of not more than 175, 150, or 125. In some embodiments, n and m are selected such the copolymer comprises at least 25, 26, 27, 28, 29, or 30 mol % of repeat units including R groups. In some embodiments, n and m are selected such the copolymer comprises not more than 85, 80, 75, 70, 65, or 60 mol % of repeat units including R groups.

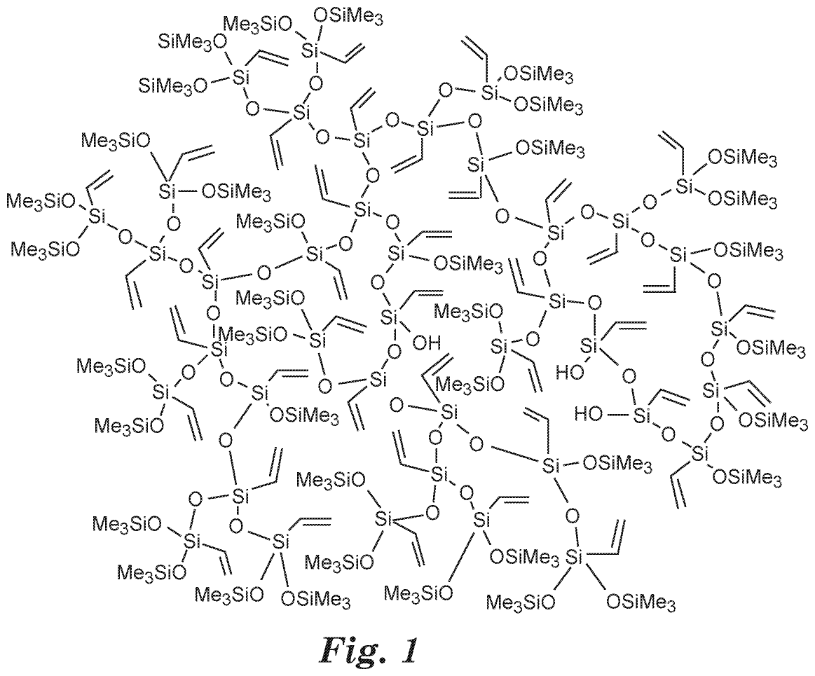

In some embodiments, each R is vinyl. In one naming convention, the R³ group is included in the name of the polymer. An example of a branched silsesquioxane polymer end-capped with ethoxytrimethylsilane is trimethyl silyl poly(vinylsilsesquioxane). The three-dimensional branched network structure of this polymer can be depicted as shown in FIG. 1.

In some embodiments, R is Y-Z, wherein Y-Z is allyl, allylphenylpropyl, 3-butenyl, docosenyl, or hexenyl, and the branched silsesquioxane polymer is trimethylsilyl poly(allylsilsesquioxane). trimethylsilyl poly(allylphenylpropylsilsesquioxane), trimethylsilyl poly(3-butenylsilsesquioxane), trimethylsilyl poly(docosenyl silsesquioxane), or trimethylsilyl poly(hexenylsilsesquioxane). Examples of other useful branched silsesquioxane polymers include trimethylsilyl vinyl-co-(perfluorohexyl)ethyl silsequioxane, trimethylsilyl vinyl-co-phenyl silsesquioxane, trimethylsilyl vinyl-co-methyl silsesquioxane, trimethylsilyl vinyl-co-octadecyl silsesquioxane, trimethylsilyl vinyl-co-hydro silsesquioxane, trimethylsilyl allyl-co-(perfluorohexyl)ethyl silsequioxane, trimethylsilyl allyl-co-phenyl silsesquioxane, trimethylsilyl allyl-co-methyl silsesquioxane, trimethylsilyl allyl-co-octadecyl silsesquioxane, and trimethyl silyl allyl-co-hydro silsesquioxane.

In some embodiments, the branched silsesquioxane polymer useful in the compositions and methods of the present disclosure is free of hydrolyzed groups such as —OH group. In some embodiments, the number of hydrolyzed groups (e.g. —OH groups) is not more than 15, 10, or 5 wt. %. In some embodiments, the number of hydrolyzed groups (e.g. —OH groups) is not more than 4, 3, 2 or 1 wt. %. The branched silsesquioxane polymer and compositions of the present disclosure can exhibit improved shelf life and thermal stability in comparison to silsesquioxane polymers having higher concentrations of —OH groups.

The branched silsesquioxane polymer useful in the compositions and articles of the present disclosure can be prepared by hydrolysis and condensation of a compound having the formula R—Si(R¹)₃ and optionally a compound having the formula R²—Si(R¹)₃, wherein R and R² are as defined above in any of their embodiments, and R¹ is a hydrolyzable group. The term “hydrolyzable group” refers to a group that can react with water under conditions of atmospheric pressure. The reaction with water may optionally be catalyzed by acid or base. Suitable hydrolyzable groups include halogen (e.g., iodo, bromo, chloro); alkoxy (e.g., —O-alkyl), aryloxy (e.g., —O—aryl), acyloxy (e.g., —O—C(O)-alkyl), amino (e.g., —N(R^{A})(R^{B}), wherein each R^{A} or R^{B} is independently hydrogen or alkyl), polyalkyleneoxy; and oxime (e.g., —O—N═C—(R¹)(R²). In some embodiments, each R¹ is independently halogen or alkoxy optionally substituted by halogen. In some embodiments, each R¹ is independently chloro or alkoxy having up to 12 (or up to 6 or 4) carbon atoms. In some embodiments, each R¹ is independently methoxy or ethoxy.

When the compounds of formula R—Si(R¹)₃ and optionally R²—Si(R¹)₃ react, R¹ is converted to a hydrolyzed group, such as —OH, during hydrolysis. The Si—OH groups react with each other to form silicone-oxygen linkages such that the majority of silicon atoms are bonded to three oxygen atoms. After hydrolysis, the —OH groups are further reacted with an end-capping agent to convert the hydrolyzed group, e.g. —OH, to —OSi(R³)₃. Suitable end-capping agents include those having formulas R¹—Si(R³)₃ and O[Si(R³)₃]₂, for example. The silsesquioxane polymer comprises terminal groups having the formula —Si(R³)₃ wherein R³ is as defined above in any of its embodiments, after end-capping. Hydrolysis and condensation can be carried out by conventional methods, for example, by heating the compound of formula R—Si(R¹)₃ and optionally R²—Si(R¹)₃ in water optionally in the presence of acid or base. Further details and methods can be found in the Examples, below.

Examples of readily available compounds of formula R—Si(R¹)₃ include vinyltriethoxysilane, vinyltrimethoxysilane, allyltriethoxysilane, allyltrimethoxysilane, allylphenylpropyltriethoxysilane, 3-butenyltriethoxysilane, docosenyltriethoxysilane, and hexenyltriethoxysilane. Examples of readily available end-capping agents having formulas R¹—Si(R³)₃ and O[Si(R³)₃]₂ include n-butyldimethylmethoxysilane, t-butyldiphenylmethoxysilane, 3-chloroisobutyldimethylmethoxysilane, phenyldimethylethoxysilane, n-propyldimethylmethoxysilane, triethylethoxysilane, trimethylmethoxysilane, triphenylethoxysilane, n-octyldimethylmethoxysilane, hexamethyldisiloxane, hexaethyldisiloxane, 1,1,1,3,3,3-hexaphenyldisiloxane, 1,1,1,3,3,3-hexakis(4-(dimethylamino)phenyl)disiloxane, and 1,1,1,3,3,3-hexakis(3-fluorobenzyl)disiloxane.

In some embodiments, branched silsesquioxane copolymers can be made with two or more reactants of the formula R—Si(R¹)₃. For example, vinyltriethoxylsilane or allytriethoxysilane can be coreacted with an alkenylalkoxylsilane such as 3-butenyltriethoxysilane and hexenyltriethoxysilane. In this embodiment, the branched silsesquioxane polymers in which R is —Y—Z as described above includes the same Z group (i.e., —CH═CH₂) and different Y groups (e.g., a bond or —CH₂—, C₂H₄—, or —C₄H₈—). In some embodiments, the branched silsesquioxane polymer can comprise at least two different Z groups and the same Y group. In some embodiments, the branched silsesquioxane polymer comprises at least two reactants wherein both Y and Z are different than each other.

In some embodiments, curable silsesquioxane copolymers can be made with at least one reactant of the formula R—Si(R¹)₃ and at least one reactant of the formula R²—Si(R¹)₃. Examples of reactants of the formula R²—Si(R¹)₃ include aromatic trialkoxysilanes (e.g., phenyltrimethoxylsilane), alkyl trialkoxysilanes (e.g., methyltrimethoxylsilane and octadecyltrimethoxysilane), and fluoroalkyl trialkoxysilanes (e.g., nonafluorohexyltriethoxysilane and perfluorohexylethyl trimethoxysilane). Other commercially available R²—Si(R¹)₃ reactants include trimethylsiloxytriethoxysilane; p-tolyltriethoxysilane; n-propyltriethoxysilane; (4-perfluorooctylphenyl)triethoxysilane; pentafluorophenyltriethoxysilane; nonafluorohexyltriethoxysilane;1-naphthyltriethoxysilane; 3,4-methylenedioxyphenyltriethoxysilane; p-methoxyphenyltriethoxysilane; 3-isooctyltriethoxysilane; isobutyltriethoxysilane;(heptadecafluoro-1,1,2,2-tetrahydrodecyl)triethoxysilane; 3,5-dimethoxyphenyltriethoxysilane; 11-chloroundecyltriethoxysilane; 3-chloropropyltriethoxysilane; p-chlorophenyltriethoxysilane; chlorophenyltriethoxysilane; benzyltriethoxysilane; and 2-[(acetoxy(polyethyleneoxy)propyl]triethoxysilane.

The inclusion of the co-reactant of the formula R²—Si(R¹)₃ can be useful for enhancing certain properties depending on the selection of the R² group. For example, when R² comprises an aromatic group such as phenyl, the thermal stability of the branched silsesquioxane polymer can be improved (relative to a homopolymer of vinyltrimethoxysilane). Further, when R² comprises a fluoroalkyl group, the hydrophobicity can be improved relative to silsesquioxane polymers that do not include fluoroalkyl groups.

The amount of reactant(s) of the formula R—Si(R¹)₃ can range up to 100 mol % in the case of homopolymers, before the endcapping step. The copolymers typically comprise up to 99, 98, 97, 96, 95, 94, 93, 92, 91, or 90 mol % of reactant(s) of the formula R—Si(R¹)₃. In some embodiments, the amount of reactant(s) of the formula R—Si(R¹)₃ is up to 85, 80, 75, 70, or 60 mol %. In some embodiments, the amount of reactant(s) of the formula R—Si(R¹)₃ is at least 15, 20, 25, or 30 mol %. When present, the amount of reactant(s) of the formula R²—Si(R¹)₃ can be at least 1, 2, 3, 4, 5, 6, 7, 8, 9, or 10 mol % of the copolymer. The amount of reactant(s) of the formula R²—Si(R¹)₃ is typically up to 75 mol % or 70 mol %. In some embodiments, the amount of reactant(s) of the formula R²—Si(R¹)₃ is at least 15, 20, 25, or 30 mol %. In some embodiments, the amount of reactant(s) of the formula R²—Si(R¹)₃ is up to 65 or 60 mol %. In some embodiments, the molar ratio of reactant(s) of the formula R—Si(R¹)₃ to molar ratio to reactant(s) of the formula R²—Si(R¹)₃ ranges from about 15:1 or 10:1 to 1:4, or 1:3, or 1:2.

For more information about branched silsesquioxane polymers useful for practicing the present disclosure and the method of making them, see, for example, U.S. Pat. No. 10,066,123 (Rathore et al.).

Useful branched silsesquioxane polymers can have a wide variety of viscosities. Viscosity correlates with molecular weight, that is, it increases with increasing molecular weight. The viscosity of the branched silsesquioxane polymer useful in the compositions and articles of the present disclosure may be up to 50,000 centipoise (cps), 40,000 cps, 30,000 cps, 25,000 cps, 20,000 cps, 15,000 cps, 10,000 cps, 9,000 cps, 8,000 cps, 7,000 cps, 6,000 cps, 5,000 cps, 4,000 cps, or 3,000 cps as measured on a Brookfield DV-II+ Viscometer with the LV4 spindle. The viscosity of the branched silsesquioxane polymer useful in the compositions and articles of the present disclosure may be at least 100 cps, 200 cps, 300 cps, 400 cps, 500 cps, 600 cps, 700 cps, 800 cps, 900 cps, or 1,000 cps, as measured on a Brookfield DV-II+ Viscometer with the LV4 spindle. In some embodiments, the viscosity of the branched silsesquioxane polymer useful in the compositions and articles of the present disclosure may be in a range from 500 cps to 15,000 cps, 500 cps to 10,000 cps, 500 cps to 5,000 cps, or 1,000 cps to 3,000 cps.

The composition of the present disclosure and the first composition in the article of the present disclosure include at least one fluoropolymer. In some embodiments, the composition (in some embodiments, the first composition) contains at least 50% by weight, at least 75%, at least 80%, at least 90%, or even at least 95% by weight fluoropolymer(s) based on the total weight of the composition.

The fluoropolymer useful in the compositions and articles of the present disclosure may have a partially or fully fluorinated backbone. Suitable fluoropolymers include those that have a backbone that is at least 30% by weight fluorinated, at least 50% by weight fluorinated, and in some embodiments at least 65% by weight fluorinated; these percentages indicate the weight percent contributed by fluorine atoms in the fluoropolymer. Fluoropolymers useful for practicing the present disclosure may include one or more interpolymerized units derived from at least two principal monomers. Examples of suitable fluorinated monomers include perfluoroolefins (e.g., tetrafluoroethylene (TFE) and hexafluoropropylene (HFP), or any perfluoroolefin of the formula CF₂═CF—Rf, where Rf is fluorine or a perfluoroalkyl of 1 to 8, in some embodiments 1 to 3, carbon atoms), perfluorovinyl ethers (e.g., perfluoroalkyl vinyl ethers (PAVE) and perfluoroalkoxyalkyl vinyl ethers (PAOVE)), perfluoroallyl ethers (e.g., perfluoroalkyl allyl ethers and perfluoroalkoxyalkyl allyl ethers), halogenated fluoroolefins (e.g., trifluorochloroethylene (CTFE), 2-chloropentafluoropropene, and dichlorodifluoroethylene), and partially fluorinated olefins (e.g., vinylidene fluoride (VDF), vinyl fluoride, pentafluoropropylene, and trifluoroethylene). Suitable non-fluorinated comonomers include vinyl chloride, vinylidene chloride, and C₂-C₈ olefins (e.g., ethylene (E) and propylene (P)).

In some embodiments, the fluoropolymer useful in the compositions and articles of the present disclosure includes units from one or more monomers independently represented by formula CF₂═CF(CF₂)ₘ(OCF₂F₂ₙ)_{z}OR_{f}², wherein R_{f}² is a linear or branched perfluoroalkyl group having from 1 to 8 carbon atoms and uninterrupted or interrupted by one or more —O— groups; z is 0, 1, or 2; each n is independently 1, 2, 3, or 4; m is 0 or 1. Suitable monomers of this formula include those in which m and z are 0, and the perfluoroalkyl perfluorovinyl ethers are represented by formula CF₂═CFOR_{f}², wherein R_{f}² is perfluoroalkyl having from 1 to 8, 1 to 4, or 1 to 3 carbon atoms, optionally interrupted by one or more —O— groups. Perfluoroalkoxyalkyl vinyl ethers suitable for making a fluoropolymer include those represented by formula CF₂═CF(CF₂)ₘ(OCₙF₂ₙ)_{z}OR_{f}², in which m is 0, each n is independently from 1 to 6, z is 1 or 2, and R_{f}² is a linear or branched perfluoroalkyl group having from 1 to 8 carbon atoms and optionally interrupted by one or more —O— groups. In some embodiments, n is from 1 to 4, or from 1 to 3, or from 2 to 3, or from 2 to 4. In some embodiments, n is 1 or 3. In some embodiments, n is 3. CₙF₂ₙ may be linear or branched. In some embodiments, CₙF₂ₙ can be written as (CF₂)ₙ, which refers to a linear perfluoroalkylene group. In some embodiments, CₙF₂ₙ is —CF₂—CF₂—CF₂—. In some embodiments, CₙF₂ₙ is branched, for example, —CF₂—CF(CF₃)—. In some embodiments, (OCₙF₂ₙ)_{z} is represented by —O—(CF₂)₁₋₄—[O(CF₂)₁₋₄]₀₋₁. In some embodiments, R_{f}² is a linear or branched perfluoroalkyl group having from 1 to 8 (or 1 to 6) carbon atoms that is optionally interrupted by up to 4, 3, or 2 —O— groups. In some embodiments, R_{f}² is a perfluoroalkyl group having from 1 to 4 carbon atoms optionally interrupted by one —O— group. Suitable monomers represented by formula CF₂═CFOR_{f}² and CF₂═CF(OCₙF₂ₙ)_{z}OR_{f}² include perfluoromethyl vinyl ether, perfluoroethyl vinyl ether, perfluoropropyl vinyl ether, CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃, CF₂═CFOCF₂CF₂OCF₂CF₂CF₃ CF₂═CFOCF₂CF₂OCF₂CF₂OCF₂CF₂CF₃, CF₂═CFOCF₂CF(CF₃)—O—C₃F₇ (PPVE-2), CF₂═CF(OCF₂CF(CF₃))₂—O—C₃F₇ (PPVE-3), and CF₂═CF(OCF₂CF(CF₃))₃—O—C₃F₇ (PPVE-4). Many of these perfluoroalkoxyalkyl vinyl ethers can be prepared according to the methods described in U.S. Pat. Nos. 6,255,536 (Worm et al.) and 6,294,627 (Worm et al.).

Suitable fluoro (alkene ether) monomers include those described in U.S. Pat. No. 5,891,965 (Worm et al.) and U.S. Pat. No. 6,255,535 (Schulz et al.). Such monomers include those in which n is 0 and which are represented by formula CF₂═CF(CF₂)ₘ—O—R_{f}², wherein m is 1, and wherein R_{f}² is as defined above in any of its embodiments. Suitable perfluoroalkoxyalkyl allyl ethers include those represented by formula CF₂═CFCF₂(OCₙF₂ₙ)_{z}OR_{f}², in which n, z, and Rf₂ are as defined above in any of the embodiments of perfluoroalkoxyalkyl vinyl ethers. Examples of suitable perfluoroalkoxyalkyl allyl ethers include CF₂═CFCF₂OCF₂CF₂OCF₃, CF₂═CFCF₂OCF₂CF₂CF₂OCF₃, CF₂═CFCF₂OCF₂OCF₃, CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂═CFCF₂OCF₂CF₂(OCF₂)₃OCF₃, CF₂═CFCF₂OCF₂CF₂(OCF₂)₄OCF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, CF₂═CFCF₂OCF₂CF(CF₃)—O—C₃F₇, and CF₂═CFCF₂(OCF₂CF(CF₃))₂—O—C₃F₇. Many of these perfluoroalkoxyalkyl allyl ethers can be prepared, for example, according to the methods described in U.S. Pat. No. 4,349,650 (Krespan).

In some embodiments, the fluoropolymer useful in the compositions and articles of the present disclosure is an amorphous fluoropolymer. Amorphous fluoropolymers typically do not exhibit a melting point and exhibit little or no crystallinity at room temperature. Useful amorphous fluoropolymers can have glass transition temperatures below room temperature or up to 280° C. Suitable amorphous fluoropolymers can have glass transition temperatures in a range from −60° C. up to 280° C., −60° C. up to 250° C., from −60° C. to 150° C., from −40° C. to 150° C., from −40° C. to 100° C., or from −40° C. to 20° C. Amorphous fluoropolymers include, for example, copolymers of vinylidene fluoride and at least one terminally ethylenically-unsaturated fluoromonomer containing at least one fluorine atom substituent on each double-bonded carbon atom, each carbon atom of said fluoromonomer being substituted only with fluorine and optionally with chlorine, hydrogen, a lower fluoroalkyl radical, or a lower fluoroalkoxy radical. Specific examples of copolymers include copolymers having units from a combination of monomers as follows: VDF-HFP, TFE-P, VDF-TFE-HFP, VDF-TFE-PAVE, TFE-PAVE, E-TFE-PAVE and any of the aforementioned copolymers further including units derived from a chlorine containing monomer such as CTFE. Still further examples of suitable amorphous copolymers include copolymers having a combination of monomers as in CTFE-P.

Those skilled in the art are capable of selecting specific interpolymerized units at appropriate amounts to form an amorphous fluoropolymer. In some embodiments, the amorphous fluoropolymers comprise from 20 to 85%, in some embodiments, 50 to 80% by moles of repeating units derived from VDF and TFE, which may or may not be copolymerized with one or more other fluorinated ethylenically unsaturated monomer, such as HFP, and/or one or more non-fluorinated C₂-C₈ olefins, such as ethylene and propylene. When included, the units derived from the fluorinated ethylenically unsaturated comonomer are generally present at between 5 and 45 mole %, e.g., between 10 and 40 mole %, based on the total moles of comonomers in the fluoropolymer. When included, the units derived from the non-fluorinated comonomers are generally present at between 1 and 50 mole %, e.g., between 1 and 30 mole %, based on the total moles of comonomers in the fluoropolymer.

Examples of amorphous fluoropolymers useful in the compositions and articles of the present disclosure include a TFE/propylene copolymer, a TFE/propylene/VDF copolymer, a VDF/HFP copolymer, a TFE/VDF/HFP copolymer, a TFE/PMVE copolymer, a TFE/CF₂═CFOC₃F₇ copolymer, a TFE/CF₂═CFOCF₃/CF₂═CFOC₃F₇ copolymer, a TFE/ethyl vinyl ether (EVE) copolymer, a TFE/butyl vinyl ether (BVE) copolymer, a TFE/EVE/BVE copolymer, a VDF/CF₂═CFOC₃F₇ copolymer, an ethylene/HFP copolymer, a TFE/HFP copolymer, a CTFE/VDF copolymer, a TFE/VDF copolymer, a TFE/VDF/PMVE/ethylene copolymer, and a TFENDF/CF₂═CFO(CF₂)₃OCF₃ copolymer.

Amorphous fluoropolymers useful for practicing the present disclosure may have a Mooney viscosity in a range from 0.1 to 100 (ML 1+10) at 100° C. according to ASTM D1646-06 TYPE A. In some embodiments, amorphous fluoropolymers useful for practicing the present disclosure have a Mooney viscosity in a range from 0.1 to 25, 0.1 to 20, 0.1 to 10, or 0.1 to 5 (ML 1+10) at 100° C. according to ASTM D1646-06 TYPE A.

In some embodiments, the fluoropolymer useful in the compositions and articles of the present disclosure is an amorphous, curable fluoropolymer. Amorphous fluoropolymers can include a cure site to render them curable. In some embodiments, the fluoropolymer useful in the compositions and articles of the present disclosure comprises a chloro, bromo-, or iodo-cure site. In some embodiments, the fluoropolymer comprises a bromo- or iodo-cure site. In some of these embodiments, the fluoropolymer comprises an iodo-cure site. The cure site can be an iodo-, bromo-, or chloro-group chemically bonded at the end of a fluoropolymer chain. The weight percent of elemental iodine, bromine, or chlorine in the amorphous fluoropolymer may range from about 0.2 wt. % to about 2 wt. %, and, in some embodiments, from about 0.3 wt. % to about 1 wt. %, based on the total weight of the fluoropolymer. To incorporate a cure site end group into the amorphous fluoropolymer, any one of an iodo-chain transfer agent, a bromo-chain transfer agent or a chloro-chain transfer agent can be used in the polymerization process. For example, suitable iodo-chain transfer agents include perfluoroalkyl or chloroperfluoroalkyl groups having 3 to 12 carbon atoms and one or two iodo-groups. Examples of iodo-perfluoro-compounds include 1,3-diiodoperfluoropropane, 1,4-diiodoperfluorobutane, 1, 6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutane and mixtures thereof. Suitable bromo-chain transfer agents include perfluoroalkyl or chloroperfluoroalkyl groups having 3 to 12 carbon atoms and one or two iodo-groups.

Chloro-, bromo-, and iodo-cure site monomers may also be incorporated into the amorphous fluoropolymer by including cure site monomers in the polymerization reaction. Examples of cure site monomers include those of the formula CX₂═CX(Z), wherein each X is independently H or F, and Z is I, Br, or R_{f}—Z, wherein Z is I or Br and R_{f} is a perfluorinated or partially fluorinated alkylene group optionally containing O atoms. In addition, non-fluorinated bromo-or iodo-substituted olefins, e.g., vinyl iodide and allyl iodide, can be used. In some embodiments, the cure site monomers is CH₂═CHI, CF₂═CHI, CF₂═CFI, CH₂═CHCH₂I, CF₂═CFCF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, CF₂═CFCl, CF₂═CFCF₂Cl, or a mixture thereof.

Other cure-site monomers useful in the polymerization reaction to make a fluoropolymer include cyano-group containing monomers. Examples of cyano-group containing monomers include CF₂═CF—CF₂—O—Rf—CN; CF₂═CFO(CF₂)ᵣCN; CF₂═CFO[CF₂CF(CF₃)O]ₚ(CF₂)ᵥOCF(CF₃)CN; and CF₂═CF[OCF₂CF(CF₃)]ₖO(CF₂)ᵤCN, wherein r represents an integer from 2 to 12; p represents an integer from 0 to 4; k represents 1 or 2; v represents an integer from 0 to 6; u represents an integer from 1 to 6, Rf is a perfluoroalkylene or a bivalent perfluoroether group. Specific examples of cyano-group containing fluorinated monomers include perfluoro (8-cyano-5-methyl-3,6-dioxa-1-octene), CF₂═CFO(CF₂)₅CN, and CF₂═CFO(CF₂)₃OCF(CF₃)CN, CF₂═CFOCF₂CF(CF₃)OCF₂CF₂CN, CF₂═CFOCF₂CF(CF₃)OCF₂CF(CF₃)CN, and CF₂═CFOCF₂CF(CF₃)OCF₂CF₂CN.

The chain transfer agents having the cure site and/or the cure site monomers can be fed into the reactor by batch charge or continuously feeding. Because feed amount of chain transfer agent and/or cure site monomer is relatively small compared to the monomer feeds, continuous feeding of small amounts of chain transfer agent and/or cure site monomer into the reactor is difficult to control. Continuous feeding can be achieved by a blend of the iodo-chain transfer agent in one or more monomers. Examples of monomers useful for such a blend include hexafluoropropylene (HFP) and perfluoromethyl vinyl ether (PMVE).

In some embodiments, the fluoropolymer useful in the compositions and articles of the present disclosure is a thermoplastic fluoropolymer. Useful thermoplastic fluoropolymers are typically semi-crystalline and melt processable with melt flow indexes in a range from 0.01 grams per ten minutes to 10,000 grams per ten minutes (20 kg/372° C.). Suitable semi-crystalline fluoropolymers can have melting points in a range from 50° C. up to 325° C., from 100° C. to 325° C., from 150° C. to 325° C., from 100° C. to 300° C., or from 80° C. to 290° C. A semi-crystalline fluoropolymer, when evaluated by differential scanning calorimetry (DSC), typically has at least one melting point temperature (Tₘ) of at least 50° C., at least 60° C., or at least 70° C. and a measurable enthalpy, for example, greater than 0 J/g, or even greater than 0.01 J/g. The enthalpy is determined by the area under the curve of the melt transition as measured by DSC using the method described in U.S. Pat. Appl. Pub. No. 2018/0208743 (Fukushi et al.) and expressed as Joules/gram (J/g). Any of the monomers described above can be useful for making fluoropolymers can be useful for making thermoplastic fluoropolymers, and a person skilled in the art is capable of selecting specific interpolymerized units at appropriate amounts to form a semi-crystalline fluoropolymer.

In some embodiments, the semi-crystalline fluoropolymer useful for practicing the present disclosure is a random fluorinated copolymer having units derived from at least the following monomers: tetrafluoroethylene (TFE), hexafluoropropylene (HFP), and vinylidene fluoride (VDF). In some embodiments, the fluoropolymer is derived at least 20, 25 or even 30 wt. % and at most 40, 50, 55, or even 60 wt. % TFE; at least 10, 15, or even 20 wt. % and at most 25 or even 30 wt. % HFP; and at least 15, 20, or even 30 wt. % and at most 50, 55, or even 60 wt. % VDF. In some embodiments, the semi-crystalline fluoropolymer has a Melt Flow Index (MFI) greater than 5, 5.5, 6, or even 7 g/10 min at 265° C. and 5 kg. MFI or Melt Flow Rate (MFR) can be used as a measure of the ease of the melt of a thermoplastic fluoropolymer to flow. As MFI is higher, flow is better. MFI is also an indirect measurement of molecular weight. As MFI is higher, the molecular weight is lower.

Further examples of semi-crystalline fluoropolymers include copolymers having units from a combination of the following monomers: VDF-CTFE, CTFE-TFE-P, VDF-CTFE-HFP, CTFE-TFE-PAVE, and CTFE-E-TFE-PAVE.

In some embodiments, the semi-crystalline fluoropolymer useful in the compositions and articles of the present disclosure is a block copolymer having at least one semi-crystalline block. In some embodiments, the block copolymer includes at least A and B blocks in which the A block is a copolymer having units derived from at least the following monomers: tetrafluoroethylene (TFE), hexafluoropropylene (HFP), and vinylidene fluoride (VDF). In some embodiments, the A block comprises 30 wt. % to 85 wt. % TFE; 5 wt. % to 40 wt. % HFP; and 5 wt. % to 55 wt. % VDF; 30 wt. % to 75 wt. % TFE; 5 wt. % to 35 wt. % HFP; and 5 wt. % to 50 wt. % VDF; or even 40 wt. % to 70 wt. % TFE; 10 wt. % to 30 wt. % HFP; and 10 wt. % to 45 wt. % VDF. The B block is a copolymer derived from at least the following monomers: hexafluoropropylene (HFP), and vinylidene fluoride (VDF). In some embodiments, the B block comprises 25 wt. % to 65 wt. % VDF and 15 wt. % to 60 wt. % HFP; or even 35 wt. % to 60 wt. % VDF and 25 wt. % to 50 wt. % HFP. Further details regarding such block copolymers and methods of making them can be found in U.S. Pat. Appl. Publ. No. 2018/0194888 (Mitchell et al.).

Other fluorinated block copolymers having at least one semi-crystalline segment may also be useful in the compositions and articles of the present disclosure. In some embodiments, the A block is a copolymer having units derived from TFE and a perfluoroolefin, for example, having 2 to 8 carbon atoms (e.g., hexafluoropropylene (HFP)). Generally, these perfluoroolefins are used in amounts of at least 2 wt. %, 3, wt. % or 4 wt. % and at most 5 wt. %, 10 wt. %, 15 wt. %, or 20 wt. %. Other comonomers may be added in small amounts (e.g., less than 0.5 wt. %, 1 wt. %, 2 wt. %, 3 wt. %, or 5 wt. %). Such comonomers can include fluorinated vinyl and allyl ethers as described above. In some embodiments, the A block is a copolymer having units derived from TFE or CTFE (e.g., at least 40 wt. % or 45 wt. %; and at most 50 wt. %, 55 wt. %, or 60 wt. %) and a non-fluorinated olefin (e.g., at least 40 wt. % or 45 wt . %; and at most 50 wt. %, 55 wt. %, or 60 wt. %). Such non-fluorinated olefins comprise 2 to 8 carbon atoms (e.g., ethylene, propylene, and isobutylene). Other comonomers may be added in small amounts (e.g., at least 0.1 wt. %, 0.5 wt. %, or 1 wt. % and at most 3 wt. %, 5 wt. %, 7 wt. %, or 10 wt. %). Such comonomers can include fluorinated olefins (e.g., VDF or HFP) and fluorinated vinyl and allyl ethers as described above. In some embodiments, the A block is a copolymer having units derived from VDF; derived from only VDF or VDF and small amounts (e.g., at least 0.1 wt. %, 0.3 wt. %, or 0.5 wt. % and at most 1 wt. %, 2 wt. %, 5 wt. %, or 10 wt. %) of other fluorinated comonomers such as fluorinated olefins such as HFP, TFE, and trifluoroethylene.

The thermoplastic fluoropolymer useful for the compositions and articles of the present disclosure, including any of the embodiments of the semi-crystalline fluoropolymers described above, can include at least one of iodo-, bromo-, chloro-, or cyano-cure sites. The cure sites can be incorporated into the fluoropolymer using the cure site monomers and/or chain transfer agents described above in any of their embodiments. In some embodiments, thermoplastic fluoropolymer includes at least 0.05 wt. %, at least 0.1 wt. %, or at least 0.5 wt. % and at most 0.8 wt. % or at most 1 wt. % elemental chlorine, bromine, or iodine based on the weight of the fluoropolymer. Fluoropolymers including CTFE units would include a higher wt. % of elemental chlorine.

Curable block copolymers including cyano-cure sites or incorporated bisolefin monomers as described in Int. Pat. Appl. Pub. Nos. WO2018/136324 (Mitchell et al.) and WO 2018/136331 (Mitchell et al.) may also be useful semi-crystalline fluoropolymers for the compositions and articles of the present disclosure.

A fluoropolymer is typically prepared by a sequence of steps, which can include polymerization, coagulation, washing, and drying. In some embodiments, an aqueous emulsion polymerization can be carried out continuously under steady-state conditions. In this embodiment, for example, an aqueous emulsion of monomers (e.g., including any of those described above), water, emulsifiers, buffers and catalysts are fed continuously to a stirred reactor under optimum pressure and temperature conditions while the resulting emulsion or suspension is continuously removed. In some embodiments, batch or semibatch polymerization is conducted by feeding the aforementioned ingredients into a stirred reactor and allowing them to react at a set temperature for a specified length of time or by charging ingredients into the reactor and feeding the monomers into the reactor to maintain a constant pressure until a desired amount of polymer is formed. After polymerization, unreacted monomers are removed from the reactor effluent latex by vaporization at reduced pressure. The fluoropolymer can be recovered from the latex by coagulation.

The polymerization is generally conducted in the presence of a free radical initiator system, such as ammonium persulfate. The polymerization reaction may further include other components such as chain transfer agents and complexing agents. The polymerization is generally carried out at a temperature in a range from 10° C. and 100° C., or in a range from 30° C. and 80° C. The polymerization pressure is usually in the range of 0.3 MPa to 30 MPa, and in some embodiments in the range of 2 MPa and 20 MPa.

Adjusting, for example, the concentration and activity of the initiator, the concentration of each of the reactive monomers, the temperature, the concentration of the chain transfer agent, and the solvent using techniques known in the art can control the molecular weight of the fluoropolymer. In some embodiments, amorphous fluoropolymers useful for practicing the present disclosure have weight average molecular weights in a range from 10,000 grams per mole to 200,000 grams per mole. In some embodiments, the weight average molecular weight is at least 15,000, 20,000, 25,000, 30,000, 40,000, or 50,000 grams per mole up to 100,000, 150,000, 160,000, 170,000, 180,000, or up to 190,000 grams per mole. Amorphous fluoropolymers disclosed herein typically have a distribution of molecular weights and compositions. Weight average molecular weights can be measured, for example, by gel permeation chromatography (i.e., size exclusion chromatography) using techniques known to one of skill in the art.

In some embodiments, the fluoropolymers useful in the composition and article of the present disclosure are curable by a peroxide curing reaction. This means the fluoropolymers are curable by one or more peroxide curing agents or the radicals generated by the peroxide curing agents. Peroxide curatives include organic or inorganic peroxides. Organic peroxides, particularly those that do not decompose during dynamic mixing temperatures, can be useful. The composition of the present disclosure and/or first composition and/or second composition in the article of the present disclosure can include a peroxide. In some embodiments, the peroxide is an acyl peroxide. Acyl peroxides tend to decompose at lower temperatures than alkyl peroxides and allow for lower temperature curing. In some of these embodiments, the peroxide is di(4-t-butylcyclohexyl)peroxydicarbonate, di(2-phenoxyethyl)peroxydicarbonate, di(2,4-dichlorobenzoyl) peroxide, dilauroyl peroxide, decanoyl peroxide, 1,1,3,3-tetramethylethylbutylperoxy-2-ethylhexanoate, 2,5-dimethyl-2,5-di(2-ethylhexanoylperoxy)hexane, disuccinic acid peroxide, t-hexyl peroxy-2-ethylhexanoate, di(4-methylbenzoyl) peroxide, t-butyl peroxy-2-ethylhexanoate, benzoyl peroxide, t-butylperoxy 2-ethylhexyl carbonate, or t-butylperoxy isopropyl carbonate. In some of these embodiments, the peroxide is benzoyl peroxide or a substituted benzoyl peroxide (e.g., di(4-methylbenzoyl) peroxide or di(2,4-dichlorobenzoyl) peroxide). In some embodiments, the composition or article of the present disclosure includes at least one of benzoyl peroxide, dicumyl peroxide, di-tert-butyl peroxide, 2,5-di-methyl-2,5-di-tert-butylperoxyhexane, 2,4-dichlorobenzoyl peroxide, 1,1-bis(tert-butylperoxy)-3,3,5-trimethylchlorohexane, tert-butyl peroxy isopropylcarbonate (TBIC), tert-butyl peroxy 2-ethylhexyl carbonate (TBEC), tert-amyl peroxy 2-ethylhexyl carbonate, tert-hexylperoxy isopropyl carbonate, carbonoperoxoic acid, O,O′-1,3-propanediyl OO,OO′-bis(1,1-dimethylethyl) ester, tert-butylperoxy benzoate, t-hexyl peroxy-2-ethylhexanoate, t-butyl peroxy-2-ethylhexanoate, di(4-methylbenzoyl) peroxide, laurel peroxide, or cyclohexanone peroxide. The peroxide is present in the composition or first composition in an amount effective to cure the composition. In some embodiments, the peroxide is present in the composition in a range from 0.5% by weight to 10% by weight based on the weight of the fluoropolymer in the composition. In some embodiments, the peroxide is present in the composition in a range from 1% by weight to 5% by weight based on the weight of the fluoropolymer in the composition.

In some embodiments, compositions and articles of the present disclosure include a crosslinker, which may be useful, for example, for providing enhanced mechanical strength in the final cured articles. Examples of useful crosslinkers include tri(methyl)allyl isocyanurate (TMAIC), triallyl isocyanurate (TAIC), tri(methyl)allyl cyanurate, poly-triallyl isocyanurate (poly-TAIC), xylylene-bis(diallyl isocyanurate) (XBD), N,N′-m-phenylene bismaleimide, diallyl phthalate, tris(diallylamine)-s-triazine, triallyl phosphite, diallyl ether of glycerin, triallylphosphate, diallyl adipate, diallylmelamine, 1,2-polybutadiene, ethyleneglycol diacrylate, diethyleneglycol diacrylate, and CH₂═CH—R_{f1}—CH═CH₂, wherein R_{f1} is a perfluoroalkylene having from 1 to 8 carbon atoms. The crosslinker is typically present in an amount of 1% by weight to 10% by weight based on the weight of the fluoropolymer in the composition or first composition. In some embodiments, the crosslinker is present in a range from 2% by weight to 5% by weight based on the weight of the fluoropolymer in the composition or first composition.

Compositions according to the present disclosure and/or useful in the articles of the present disclosure can be prepared by compounding fluoropolymer, branched silsesquioxane polymer, peroxide, and optionally the crosslinker described above. Compounding can be carried out, for example, on a roll mill (e.g., two-roll mill), internal mixer (e.g., Banbury mixers), or other rubber-mixing device. Thorough mixing is typically desirable to distribute the components and additives uniformly throughout the composition so that it can cure effectively. It is typically desirable that the temperature of the composition during mixing should not rise high enough to initiate curing. For example, the temperature of the composition may be kept at or below about 50° C.

Additives such as carbon black, stabilizers, plasticizers, lubricants, fillers, and processing aids typically utilized in fluoropolymer compounding can be incorporated into the curing compositions, provided they have adequate stability for the intended service conditions. In particular, low temperature performance can be enhanced by incorporation of perfluoropolyethers. See, for example, U.S. Pat. No. 5,268,405 to Ojakaar et al. Carbon black fillers can be employed in fluoropolymers as a means to balance modulus, tensile strength, elongation, hardness, abrasion resistance, conductivity, and processability of the compositions. Suitable examples include MT blacks (medium thermal black) and large particle size furnace blacks. When used, 1 to 100 parts filler per hundred parts fluoropolymer (phr) of large size particle black is generally sufficient.

Fluoropolymer fillers may also be present in the curable compositions. Generally, from 1 to 100 phr of fluoropolymer filler can be useful. The fluoropolymer filler can be finely divided and easily dispersed as a solid at the highest temperature used in fabrication and curing of the composition disclosed herein. By solid, it is meant that the filler material, if partially crystalline, will have a crystalline melting temperature above the processing temperature(s) of the curable composition(s). One way to incorporate fluoropolymer filler is by blending latices. This procedure, using various kinds of fluoropolymer filler, is described in U.S. Pat. No. 6,720,360 (Grootaert et al.).

Conventional adjuvants may also be incorporated into the composition and/or first composition disclosed herein to enhance the properties of the composition. For example, acid acceptors may be employed to facilitate the cure and thermal stability of the composition. Suitable acid acceptors may include magnesium oxide, lead oxide, calcium oxide, calcium hydroxide, dibasic lead phosphite, zinc oxide, barium carbonate, strontium hydroxide, calcium carbonate, hydrotalcite, alkali stearates, magnesium oxalate, or combinations thereof. The acid acceptors can be used in amounts ranging from about 1 to about 20 parts per 100 parts by weight of the fluoropolymer.

The composition of the present disclosure can be used to make cured fluoroelastomers in the form of a variety of articles, including final articles, such as O-rings, and/or preforms from which a final shape is made, (e.g. a tube from which a ring is cut). To form an article, the composition can be extruded using a screw type extruder or a piston extruder. The extruded or pre-formed compositions can be cured in an oven at ambient pressure.

Alternatively, the composition can be shaped into an article using injection molding, transfer molding, or compression molding. Injection molding of the composition, for example, can be carried out by masticating the curable composition in an extruder screw, collecting it in a heated chamber from which it is injected into a hollow mold cavity by means of a hydraulic piston. After curing, the article can then be demolded. Advantages of injection molding process include short molding cycles, little or no preform preparation, little or no flash to remove, and low scrap rate. The branched silsesquioxane polymer in the compositions and crosslinked articles of the present disclosure may be useful, for example, for preventing or minimizing fouling of the mold.

The composition of the present disclosure can also be used to prepare cure-in-place gaskets (CIPG) or form-in-place gaskets (FIPG). A bead or thread of the composition can be deposited from a nozzle onto a substrates surface. After forming to a desired gasket pattern, the composition may be cured in place with a heat or in an oven at ambient pressure.

The composition of the present disclosure can also be useful as a fluoroelastomer caulk, which can be useful, for example, to fill voids in, coat, adhere to, seal, and protect various substrates from chemical permeation, corrosion, and abrasion, for example. Fluoroelastomer caulk can be useful as a joint sealant for steel or concrete containers, seals for flue duct expansion joints, door gaskets sealants for industrial ovens, fuel cell sealants or gaskets, and adhesives for bonding fluoroelastomer gaskets (e.g., to metal). In some embodiments, the composition can be dispensed by hand and cured with heat at ambient pressure.

For any of the above embodiments of the composition and/or first composition, the cure temperature can be selected based on the decomposition temperature of the peroxide. For example, a temperature can be selected that is above (in some embodiments, at least 10° C., 20° C., 30° C., 40° C., or at least 50° C. above) the ten-hour half-life temperature of the peroxide. In some embodiments, the cure temperature is above 100° C. In some embodiments, the cure temperature is in a range from 120° C. to 180° C. The cure time can be at least 5, 10, 15, 20, or 30 minutes up to 24 hours, depending on the composition of the amorphous fluoropolymer and the cross-sectional thickness of the cured article.

A cured fluoroelastomer can be post-cured, for example, in an oven at a temperature of about 120° C. to 300° C., in some embodiments, at a temperature of about 150° C. to 250° C., for a period of about 30 minutes to about 24 hours or more, depending on the chemical composition of the fluoroelastomer and the cross-sectional thickness of the sample.

As described above, the beneficial properties of fluoropolymers include high temperature resistance, chemical resistance (e.g., resistance to solvents, fuels, and corrosive chemicals), and non-flammability. At least because of these beneficial properties, fluoropolymers find wide application particularly where materials are exposed to high temperatures or aggressive chemicals. For example, because of their excellent resistance to fuels and their good barrier properties, fluoropolymers are commonly used in fuel management systems including fuel tanks, and fuel lines (e.g., fuel filler lines and fuel supply lines).

However, fluoropolymers are generally more expensive than polymers that do not contain fluorine. To reduce the overall cost of an article, a fluoropolymer is sometimes used in combination with other materials. For example, articles containing fluoropolymers can be prepared as multi-layer articles using a relatively thin layer of a fluoropolymer, typically a fluoroelastomer, at the interface where chemical resistance is required, such as an inner or an outer layer. The other layers of such multi-layer articles contain non-fluorine containing elastomers, such as EPDM rubber or silicone-containing polymers. One requirement of those layered articles is a firm and reliable bond between the fluoropolymer layer and its adjacent layer(s). However, satisfactory bonding of a fluoropolymer to other polymers, particularly silicones, is often difficult, particularly after prolonged exposure to elevated temperatures.

The present disclosure provides an article comprising a first composition comprising a fluoropolymer in contact with a second composition comprising a silicone, wherein at least one of the first composition or second composition comprises the branched silsesquioxane polymer described above in any of its embodiments. Silicone resins useful in the second composition are also called polysiloxanes, which comprise repeating —Si—O—Si— units. Typically, the polysiloxanes comprise polydimethylsiloxane. In some embodiments, the silicone resins are curable. The silicone-containing polymers may become elastic upon curing or their elastic properties may increase upon curing; accordingly, silicones useful for the articles of the present disclosure include those that are elastomeric. The silicone-containing polymers may be curable by a peroxide curing reaction. Such peroxide curable silicone-containing polymers typically comprise methyl and/or vinyl groups. The same peroxides and combinations of peroxides and crosslinkers described above with respect to the peroxide-curable fluoropolymers may be used. The cross-link density of the cured silicone polymer may depend on both the vinyl or methyl level of the silicone polymer and the amount of curing agent. Peroxides are typically used in amount between 0.1 to 10 parts per hundred parts of the curable silicone polymer. In some embodiments, the second composition comprising a silicone includes from 0.5 to 3 parts per hundred parts of a peroxide. The peroxide used in the second composition of the article may be the same or different from the one in the first composition. For example, different agents which are activated at different temperatures can be used such that the fluoropolymer in the first composition may cure before or after the silicone polymer in the second composition. Peroxide curable silicone polymers are commercially available, for example under the trade designation Elastosil R 401/60 and Elastosil R 760/70 from Wacker Chemie AG, Munich, Germany.

In some embodiments, the silicone in the second composition is represented by formula:

(R′)(R³)₂SiO[(R²SiO]ᵣ—[(ZY)R²SiO]ₛ—Si(R³)₂(R′).

In this formula, each R′ is independently R³ or a terminal unit represented by formula —Y—Z; R², R³, Y, and Z are as defined above in any of their embodiments; and r′+s′ is in a range from 10 to 500, 10 to 400, 10 to 300, 12 to 300, 13 to 300, 13 to 200, 10 to 100, 10 to 50, or 10 to 30. In some embodiments, r′ is 0, and s′ is in a range from 20 to 200, 30 to 100, or 10 to 100. In some embodiments, s′ is 0, and r′ is in a range from 20 to 200, 30 to 100, or 10 to 100. In some embodiments when s′ is 0, at least one R′ is represented by formula —Y—Z. In some embodiments, at least 40 percent, and in some embodiments at least 50 percent, of the R² and R³ groups are phenyl, methyl, or combinations thereof. For example, at least 60 percent, at least 70 percent, at least 80 percent, at least 90 percent, at least 95 percent, at least 98 percent, or at least 99 percent of the R² and R³ groups can be phenyl, methyl, or combinations thereof. In some embodiments, at least 40 percent, and in some embodiments at least 50 percent, of the R² and R³ groups are methyl. For example, at least 60 percent, at least 70 percent, at least 80 percent, at least 90 percent, at least 95 percent, at least 98 percent, or at least 99 percent of the R² and R³ groups can be methyl. In some embodiments, each R² and R³ is methyl. Although the formula is shown as a block copolymer, it should be understood that the divalent units can be randomly positioned in the copolymer. Thus, polyorganosiloxanes useful for practicing the present disclosure also include random copolymers.

The silicone-containing polymers may alternatively or in addition also be curable by use of metal containing compounds. This means they can be cured by a so-called addition curing system. In this system the polymers are cured by using a metal catalyst. Suitable metal catalysts include platinum containing compounds, especially platinum salts or platinum complexes having organic ligands or residues. The corresponding curable silicones are referred to as “platinum-curable”. Silicone-containing polymers that are curable by metal compounds typically contain reactive groups such as vinyl groups. Examples of suitable platinum group metal containing catalysts include platinic chloride, salts of platinum, chloroplatinic acid, and various complexes. In some embodiments, transition metal catalyst is chloroplatinic acid, complexed with a siloxane such as tetramethylvinylcyclosiloxane (i.e. 1,3,5,7-tetramethyl-1,3,5,7-tetravinylcyclosiloxane) or 1,3-divinyl-1,1,3,3-tetramethyldisiloxane. In some embodiments, the transition metal catalyst is a platinum(0)-1,3-divinyl-1,1,3,3-tetramethyldisiloxane complex (i.e., Karstedt's catalyst).

The silicone polymer composition may also contain silicones comprising Si-H groups. Those silicones may act as crosslinkers, for example, for vinyl-substituted silicones.

Metal-curable silicone polymers can be used as a one-part silicone system or a two-part silicone system. One-part metal (platinum) curable silicone polymers are commercially available, for example, under the trade designation Elastosil R plus 4450/60 and Elastosil R plus 4110/70 from Wacker Chemie AG, Germany. In a two-part silicone system, also referred to as liquid silicone rubber (LSR), a vinyl-functional silicone polymer (typically identified as part A) may be vulcanized in presence of a silicone having Si—H groups (part B). Part A typically contains the platinum catalyst. Two-part platinum curable silicone systems are commercially available, for example under the trade designation Elastosil R 533/60 A/B and Elastosil LR 7665 from Wacker Chemie, AG and Silastic 9252/900P from Dow Corning. Examples of useful platinum catalysts are known in the art. The platinum catalyst is typically used in amounts between 2 and 200 ppm platinum.

In addition to the silicone resin, the second composition may contain curing agents, catalysts and crosslinkers, including, for example, the peroxides and crosslinkers described above. The second composition may further include other fillers and additives including those described above in connection with fluoropolymer compositions.

In some embodiments of the article of the present disclosure, at least one of the first composition comprising the fluoropolymer or the second composition comprising the silicone comprises the branched silsesquioxane polymer described above in any of its embodiments. In some embodiments, the first composition includes the branched silsesquioxane polymer. In some embodiments, the second composition includes the branched silsesquioxane polymer. In some embodiments, both the first and the second composition include the branched silsesquioxane polymer. In some embodiments, the same branched silsesquioxane polymer is used in both the first and second compositions. In some embodiments, branched silsesquioxane polymers used in the first and second compositions are independently selected.

A wide range of amounts of the branched silsesquioxane polymer described above may be useful in the first and/or second composition. When added to the fluoropolymer composition, the branched silsesquioxane polymer can be used in a range from 0.1% and 10% by weight, in some embodiments from 0.5% and 5% by weight, based on the weight of fluoropolymer. When added to the silicone composition, the branched silsesquioxane polymer can be used in an amount from 0.1% to 15% by weight, in some embodiments from 1% and 10% by weight, based on the weight of silicone in the composition. When added to both the fluoropolymer composition and the silicone composition, the branched silsesquioxane polymer can be used in an amount of 0.1% to 5% by weight in the fluoropolymer composition (based on the weight of the fluoropolymer in the composition) and in an amount of 0.1% to 10% by weight in the silicone composition (based on the weight of the silicone polymer in the composition).

In some embodiments, the first composition is formed into a sheet, a layer, a laminate, a tube, or other article, and the second composition is formed into a sheet, a layer, a laminate, a tube, or other article.

The compositions may then be laminated together using effective heat and pressure for an effective time to create a strong bond. As is known by one of ordinary skill, the effective amount of heat, pressure, and time are interrelated, and may also depend in the specific fluoropolymer and silicone compositions. Effective and optimum bonding conditions may be determined by routine experimentation.

For example, bonding may be achieved by contacting the first and second compositions such that a common interface is formed. The compositions are then subjected to conditions such that at least the fluoropolymer cures. In some embodiments, the silicone polymer may also cure. It may be sufficient to cure locally, i.e. to cure only the parts of the compositions that form the common interface.

In some embodiments, curing and bonding may be achieved by heating the first composition while it is in contact with second composition to a temperature of 120° C. to 200° C. for 1 to 120 minutes (e.g., 140° C. to 180° C. for 3 to 60 minutes). In some embodiments, the heating may be carried out while simultaneously applying pressure, e.g., at least 5 MPa, at least 10 MPa, or even at least 25 MPa. Generally, pressures greater than 200 MPa are not required. In some embodiments, the pressure is no greater than 100 MPa, e.g. no greater than 50 MPa.

Alternatively, both compositions in the article may be in molten form, for example, during co-extrusion or injection molding. It is also possible to coat one of the compositions onto the other. For example, one of the compositions may be a liquid or in the form of a liquid coating composition. Such a composition may be applied as a coating to the other composition, which may be provided in the form of, e.g., a layer, a sheet, a film a laminate, a tube or other article.

Alternative methods of forming articles of the present disclosure include coextrusion, sequential extrusion, and injection molding. It is also possible to prepare a multilayer article by a repeated cycle of coating a liquid silicone polymer composition onto a layer of a fluoropolymer composition. It is also possible to form one or more individual layers by extrusion coating, e.g., using a crosshead die.

The heat and pressure of the method by which the layers are brought together (e.g. extrusion or lamination) can be sufficient to provide adequate adhesion between the compositions. It may, however, be desirable to further treat the resulting article, for example, with additional heat, pressure, or both, to enhance the bond strength between the layers and to post cure the laminate. One way of supplying additional heat when the article is prepared by extrusion is by delaying the cooling of the article at the conclusion of the extrusion process.

Alternatively, additional heat energy can be added to the article by laminating or extruding the compositions at a temperature higher than necessary for merely processing the composition. As another alternative, the finished article can be held at an elevated temperature for an extended period of time. For example, the finished article can be placed in a separate apparatus for elevating the temperature of the article such as an oven, an autoclave or heated liquid bath. Combinations of these methods can also be used.

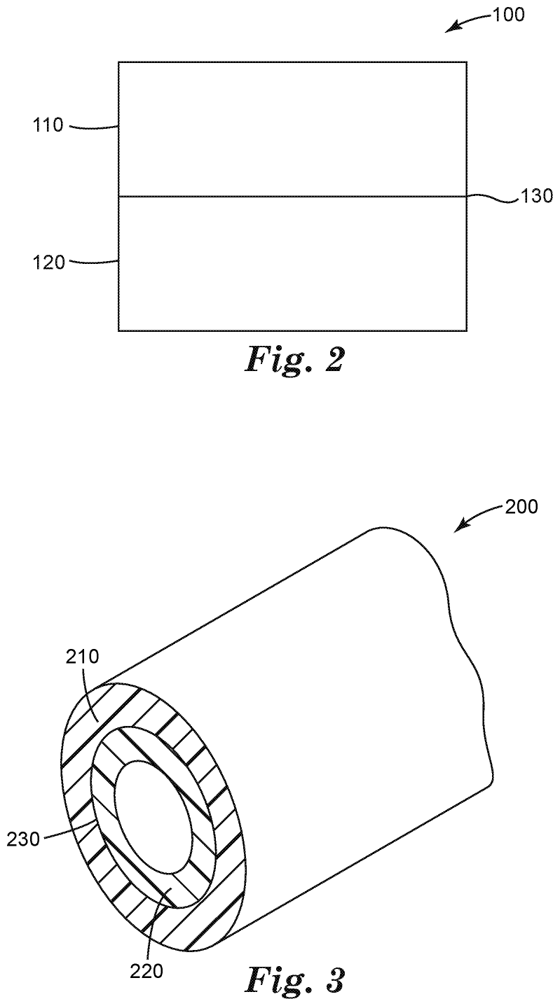

An example of an article according to some embodiments of the present disclosure, in the form of a simple two-layer laminate, is shown in the FIG. 2. Article (100) comprises first layer (110), bonded to second layer (120) at interface (130). First layer (110) comprises the first composition, i.e., the fluoropolymer containing composition. Second layer (120) comprises the second composition, i.e., the silicone polymer containing composition. One or both the first and second compositions comprise a branched silsesquioxane polymer described above in any of its embodiments.

An example of an article according to some embodiments of the present disclosure, in the form of a simple two-layer hose, is shown in the FIG. 3. Article (200) comprises first layer (210), bonded to second layer (220) at interface (230). First layer (210) comprises the first composition, i.e., the fluoropolymer containing composition. Second layer (220) comprises the second composition, i.e., the silicone polymer containing composition. One or both the first and second compositions comprise a branched silsesquioxane polymer described above in any of its embodiments.

Any article in which a fluoropolymer containing layer is bonded to the silicone polymer layer can be made. Such articles include hoses, tubes, O-rings, seals, diaphragms, valves, containers or simple laminates. The articles may be used, for example, in motor vehicles, such as motor crafts, aircrafts and watercrafts and include turbo charger hoses, fuel lines, and fuel tanks. Articles may also be used in medical applications, for examples as tubes, hoses or lining in a medical apparatus or valves, O-rings and seals in a medical apparatus or device.

Hoses can be made in which a layer of fluoropolymer (typically an elastomer), generally as an innermost layer, is bonded to a silicone polymer (typically a silicone rubber), as the outer layer or as a middle layer.

The Examples below demonstrate that a wide variety of branched silsesquioxane polymer are useful for crosslinking a wide variety of fluoropolymers. Typically, when the branched silsesquioxane polymer is used to crosslink a fluoropolymer to make a fluorolastomer, the tear resistance of the fluoroelastomer is higher than when a comparative fluoroelastomer is made in the absence of the branched silsesquioxane polymer. See, for example, Examples 6 to 8 versus Comparative Example 2 in the Examples below. A comparative fluoroelastomer has the same fluoropolymer, fillers, peroxide, and crosslinkers as the fluoroelastomer of the present disclosure except the comparative fluoroelastomer is not crosslinked with the branched silsesquioxane polymer. Typically, and unexpectedly, fluoroelastomers crosslinked with the branched silsesquioxane polymer have much lower compression set than fluoroelastomers crosslinked with polysiloxanes that include aliphatic carbon-carbon double bonds. See, for example, Examples 1, 3, 9, and 11 versus Comparative Examples 3 to 5 in the Examples, below.

### Some Embodiments of the Disclosure

In a first embodiment, the present disclosure provides a composition comprising:

a fluoropolymer; and

a branched silsesquioxane polymer comprising terminal —Si(R³)₃ groups and units represented by formula:

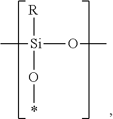

wherein

* represents a bond to another silicon atom in the branched silsesquioxane polymer;

each R is independently an organic group comprising an aliphatic carbon-carbon double bond; and

each R³ is independently a non-hydrolyzable group with the proviso that one R³ may be hydrogen.

In a second embodiment, the present disclosure provides the composition of the first embodiment, further comprising a non-fluorinated, curable polymer.

In the third embodiment, the present disclosure provides the composition of the second embodiment, wherein the non-fluorinated, curable polymer is an ethylene-propylene-diene or a silicone.

In a fourth embodiment, the present disclosure provides an article comprising a first composition comprising a fluoropolymer in contact with a second composition comprising a silicone, wherein at least one of the first composition or second composition comprises a branched silsesquioxane polymer comprising terminal —Si(R³)₃ groups and units represented by formula:

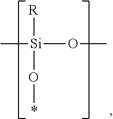

wherein

* represents a bond to another silicon atom in the branched silsesquioxane polymer;

each R is independently an organic group comprising an aliphatic carbon-carbon double bond; and

each R³ is independently a non-hydrolyzable group with the proviso that one R³ may be hydrogen.

In a fifth embodiment, the present disclosure provides the composition or article of the third or fourth embodiment, wherein the silicone is a curable polydimethysiloxane.

In a sixth embodiment, the present disclosure provides the composition or article of any one of the first to fifth embodiments, wherein the branched silsesquioxane polymer further comprises units represented by formula:

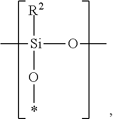

wherein.

* represents a bond to another silicon atom in the branched silsesquioxane polymer; and

each R² is independently hydrogen or a non-hydrolyzable group that does not include an aliphatic carbon-carbon double bond.

In a seventh embodiment, the present disclosure provides the composition or article of the sixth embodiment, wherein each R² is independently hydrogen, alkyl, aryl, alkylene at least one of interrupted or terminated by arylene or heterocyclylene, wherein alkyl and alkylene at least one of interrupted or terminated by arylene or heterocyclylene are unsubstituted or substituted with halogen and optionally interrupted by at least one catenated —O—, and wherein aryl, arylene, and heterocyclylene are unsubstituted or substituted by at least one alkyl, alkoxy, halogen, or combination thereof.

In an eighth embodiment, the present disclosure provides the composition or article of the sixth or seventh embodiment, wherein each R² is independently unsubstituted alkyl or alkyl substituted by fluoro.

In a ninth embodiment, the present disclosure provides the composition or article of any one of the first to eighth embodiments, wherein each R is independently represented by —Y—Z, wherein Y is a bond, alkylene, arylene, or alkylene at least one of interrupted or terminated by arylene, —O—, —NR′—, or a combination thereof, and wherein Z is —CH═CH₂, —O—CH═CH₂, —O—C(O)—CH═CH₂, —O—C(O)—C(CH₃)═CH₂, —NR′—C(O)—CH═CH₂, —NR′—C(O)—C(CH₃)═CH₂, wherein R′ is hydrogen or alkyl having up to four carbon atoms.

In a tenth embodiment, the present disclosure provides the composition or article of the ninth embodiment, wherein Y is a bond or —CH₂—, and wherein Z is —CH═CH₂.

In an eleventh embodiment, the present disclosure provides the composition or article any one of the first to tenth embodiments, wherein each R³ is independently alkyl, aryl, or alkyl substituted by fluoro and optionally interrupted by at least one catenated —O— group.

In a twelfth embodiment, the present disclosure provides the composition or article of the eleventh embodiment, wherein each R³ is independently alkyl having up to four carbon atoms.

In a thirteenth embodiment, the present disclosure provides the composition or article of any one of the first to twelfth embodiments, wherein the branched silsesquioxane polymer is present in the composition in a range from 1 percent to 10 percent by weight, based on the total weight of the fluoropolymer or silicone in the composition, the first composition, and/or the second composition.

In a fourteenth embodiment, the present disclosure provides the composition or article of any one of the first to thirteenth embodiments, wherein the fluoropolymer is an amorphous, curable fluoropolymer.

In a fifteenth embodiment, the present disclosure provides the composition or article of any one of the first to thirteenth embodiments, wherein the fluoropolymer is a semi-crystalline fluoropolymer.

In a sixteenth embodiment, the present disclosure provides the composition or article of any one of the first to fifteenth embodiments, wherein the fluoropolymer comprises at least one of chloro-, bromo-, iodo-, or cyano-cure sites.

In a seventeenth embodiment, the present disclosure provides the composition or article of the sixteenth embodiment, wherein the fluoropolymer comprises at least one of iodo- or bromo-cure sites.

In an eighteenth embodiment, the present disclosure provides the composition or article of any one of the first to the seventeenth embodiments, wherein the composition, the first composition, and/or the second composition further comprises a peroxide initiator.

In a nineteenth embodiment, the present disclosure provides the composition or article of the eighteenth embodiment, wherein the peroxide initiator comprises at least one of benzoyl peroxide, dicumyl peroxide, di-tert-butyl peroxide, 2,5-di-methyl-2,5-di-tert-butylperoxyhexane, 2,4-dichlorobenzoyl peroxide, 1,1-bis(tert-butylperoxy)-3,3,5-trimethylchlorohexane, tert-butyl peroxy isopropylcarbonate (TBIC), tert-butyl peroxy 2-ethylhexyl carbonate (TBEC), tert-amyl peroxy 2-ethylhexyl carbonate, tert-hexylperoxy isopropyl carbonate, carbonoperoxoic acid, O,O′-1,3-propanediyl OO,OO′-bis(1,1-dimethylethyl) ester, tert-butylperoxy benzoate, t-hexyl peroxy-2-ethylhexanoate, t-butyl peroxy-2-ethylhexanoate, di(4-methylbenzoyl) peroxide, laurel peroxide, or cyclohexanone peroxide.

In a twentieth embodiment, the present disclosure provides the composition or article of the eighteenth or nineteenth embodiment, wherein the peroxide is present in the composition, first composition, and/or second composition in a range from 0.5 percent to 10 percent by weight of the fluoropolymer or silicone in the composition.

In a twenty-first embodiment, the present disclosure provides the composition or article of any one of the first to twentieth embodiments, wherein the composition, the first composition and/or the second composition further comprises a crosslinker, wherein the crosslinker is tri(methyl)allyl isocyanurate (TMAIC), triallyl isocyanurate (TAIC), tri(methyl)allyl cyanurate, poly-triallyl isocyanurate (poly-TAIC), xylylene-bis(diallyl isocyanurate) (XBD), N,N′-m-phenylene bismaleimide, diallyl phthalate, tris(diallylamine)-s-triazine, triallyl phosphite, diallyl ether of glycerin, triallylphosphate, diallyl adipate, diallylmelamine, 1,2-polybutadiene, ethyleneglycol diacrylate, diethyleneglycol diacrylate, or CH₂═CH—R_{f2}—CH═CH₂, wherein R_{f1} is a perfluoroalkylene having from 1 to 8 carbon atoms.

In a twenty-second embodiment, the present disclosure provides the composition or article of the twenty-first embodiment, wherein the crosslinker is present in the composition, first composition, and/or second composition in a range from 1 percent to 10 percent by weight, based on the total weight of the fluoropolymer or silicone in the composition.

In a twenty-third embodiment, the present disclosure provides an article comprising a fluoropolymer crosslinked with a branched silsesquioxane polymer comprising terminal —Si(R³)₃ groups and units represented by formula:

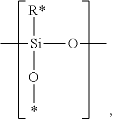

wherein

* represents a bond to another silicon atom in the branched silsesquioxane polymer;

each R* is independently an organic group comprising a carbon-carbon bond between the branched silsesquioxane polymer and the fluoropolymer or another R* group in the branched silsesquioxane polymer; and

each R³ is independently a non-hydrolyzable group with the proviso that one R³ may be hydrogen.

In a twenty-fourth embodiment, the present disclosure provides an article comprising a fluoropolymer in contact with a silicone, wherein at least one of the fluoropolymer or the silicone is crosslinked with a branched silsesquioxane polymer comprising terminal —Si(R³)₃ groups and units represented by formula:

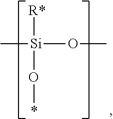

wherein

* represents a bond to another silicon atom in the branched silsesquioxane polymer;

each R* is independently an organic group comprising a carbon-carbon bond between the branched silsesquioxane polymer and the fluoropolymer, the silicone, or another R* group in the branched silsesquioxane polymer; and

each R³ is independently a non-hydrolyzable group with the proviso that one R³ may be hydrogen.

In a twenty-fifth embodiment, the present disclosure provides the article of the twenty-third or twenty-fourth embodiment, wherein the branched silsesquioxane polymer further comprises units represented by formula

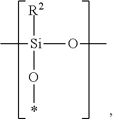

wherein.

* represents a bond to another silicon atom in the branched silsesquioxane polymer; and each R² is independently hydrogen or a non-hydrolyzable group that does not include an aliphatic carbon-carbon double bond.

In a twenty-sixth embodiment, the present disclosure provides the article of the twenty-fifth embodiment, wherein each R² is independently hydrogen, alkyl, aryl, alkylene at least one of interrupted or terminated by arylene or heterocyclylene, wherein alkyl and alkylene at least one of interrupted or terminated by arylene or heterocyclylene are unsubstituted or substituted with halogen and optionally interrupted by at least one catenated —O—, and wherein aryl, arylene, and heterocyclylene are unsubstituted or substituted by at least one alkyl, alkoxy, halogen, or combination thereof.

In a twenty-seventh embodiment, the present disclosure provides the article of the twenty-sixth embodiment, wherein each R² is independently unsubstituted alkyl or alkyl substituted by fluoro.

In a twenty-eighth embodiment, the present disclosure provides the article of any one of the twenty-third to twenty-seventh embodiments, wherein R* optionally further comprises alkylene, arylene, or alkylene at least one of interrupted or terminated by arylene, —O—, —NR′—, —O—C(O)—, —NR′—C(O)—, or a combination thereof, and wherein R′ is hydrogen or alkyl having up to four carbon atoms.

In a twenty-ninth embodiment, the present disclosure provides the article of the twenty-eighth embodiment, wherein R* is the carbon-carbon bond optionally bonded to —CH₂—.

In a thirtieth embodiment, the present disclosure provides the article of any one of the twenty-third to twenty-ninth embodiments, wherein each R³ is independently alkyl, aryl, or alkyl substituted by fluoro and optionally interrupted by at least one catenated —O— group.

In a thirty-first embodiment, the present disclosure provides the article of the thirtieth embodiment, wherein each R³ is independently alkyl having up to four carbon atoms.

In a thirty-second embodiment, the present disclosure provides the article of any one of the twenty-third to thirty-first embodiments, wherein the fluoropolymer is amorphous.

In a thirty-third embodiment, the present disclosure provides the article of any one of the twenty-third to thirty-first embodiments, wherein the fluoropolymer is semi-crystalline.

In a thirty-fourth embodiment, the present disclosure provides the article of any one of the fourth to thirty-third embodiments, wherein the article is a hose, an O-ring, a seal, a diaphragm, a valve, or a container.

The following specific, but non-limiting, examples will serve to illustrate the present disclosure.

### EXAMPLES

The following abbreviations are used in this section: g=grams, lb=pounds, f=feet, in=inches, wt %=percent by weight, min=minutes, h=hours, dNm=decinewton meters, MW=molecular weight, ° F.=degrees Fahrenheit, ° C.=degrees Celsius, TFE=tetrafluoroethylene, PMVE=perfluoromethyl vinyl ether, vinylidene fluoride=VDF, chlorotrifluoroethylene=CTFE, and hexafluoropropylene=HFP.

TABLE 1
Materials Used in the Examples

| Abbreviation | Description and Source |
|---|---|
| FPO3820 | Peroxide curing fluoropolymer (70% |
| | fluorine terpolymer, Mooney Viscosity |
| | ML1 + 10 @ 121° C. of 24, with iodine |
| | end groups), 3M Company, St. Paul, Minn. |
| FPO3620 | Peroxide curing fluoropolymer (67.5% |
| | fluorine terpolymer, Mooney Viscosity |
| | ML1 + 10 @ 121° C. of 20, with iodine |
| | end groups), 3M Company |
| FP3 | A fluorine-containing copolymer of |
| | TFE and PMVE with 72.2 wt % fluorine |
| | content, 0.3 wt % iodine content and |
| | Mooney Viscosity ML1 + 10 @ 121° C. of |
| | 40, obtained under the trade designation |
| | “3M DYNEON PFE 40Z” from 3M Company |
| FP4 | A fluoroelastomer that is derived from about |
| | 26.5% of TFE, 36.5% of HFP and 37% of |
| | VDF by weight with 0.18% of bromine and |
| | 0.15% of iodine by weight, 69.8 wt % fluorine |
| | content, and Mooney Viscosity ML1 + 10 @ |
| | 121° C. of 36 |
| FP5 | A fluoroelastomer that is derived from |
| | 56.3% of VDF, and 43.7% of CTFE by weight, |
| | 54.9% fluorine content. |
| FP6 | A fluoroelastomer derived from TFE and |
| | propylene obtained from AGC Chemicals, |
| | Exton, Pa. under the trade designation |
| | “AFLAS 150P” |
| FP7 | A fluoroelastomer that is derived from about |
| | 11% of TFE, 51% of VDF and 38% of PMVE |
| | by weight with 0.3% of iodine, 64.2% fluorine |
| | content, and Mooney viscosity ML1 + 10 @ |
| | 121° C. of 50 |
| FP8 | A fluoroelastomer that is derived from about |
| | 16% of TFE, 31% of VDF and 53% of |
| | CF₂═CFO(CF₂)₃OCF₃ by weight with 0.12% |
| | of bromine, 67.1% fluorine content, and |
| | Mooney Viscosity ML1 + 10 @ 121° C. of 95 |
| N990 | Carbon black obtained under the trade |
| | designation “N990” from Cancarb, Medicine |
| | Hat, AB, Calif. |
| TAIC | Triallyl-isocyanurate obtained under the trade |
| | designation “TAIC” from Nippon Kasei |
| | Chemical Co. Ltd., Tokyo, Japan |
| DBPH-50 | 2,5-dimethyl-2,5-di(t-butylperoxy)-hexane, |
| | 50% active, obtained under the trade designation |
| | “VAROX DBPH-50” from Vanderbilt Chemicals, |
| | LLC., Norwalk, Conn. |
| BPO | 98% Benzoyl Peroxide, available from |
| | MilliporeSigma, St. Louis, Mo. |
| VMQ | Linear vinylmethylsiloxane homopolymer, |
| | available under the trade designation VMS-T11 |
| | from Gelest, Morrisville, Pa. |
| Divinyl | Vinyl terminated polydimethylsiloxane, |
| PDMS | available under the trade designation |
| | DMS-V41 from Gelest |
| Tetra Vinyl | 1,3,5,7 Tetravinyl, 1,3,5,7 tetramethyl- |
| cyclic | cyclotetrasiloxane, available under the trade |
| siloxane | designation SIT7900.0 from Gelest |
| SLM19045 | Wacker Chemie AG, Munich, Germany |
| SLM19046 | Wacker Chemie AG |

### Test Methods

Cure rheology: Cure rheology tests were carried out using uncured, compounded samples using a rheometer (PPA 2000 by Alpha technologies, Akron, Ohio), in accordance with ASTM D 5289-93A at 177° C., no pre-heat, 12 minute elapsed time, and a 0.5 degree arc. For Examples 13 and 16, 12 minutes at 130° C. was used. Both the minimum torque (M_{L}) and highest torque attained during a specified period of time when no plateau or maximum torque (M_{H}) was obtained were measured. Also reported were the time for the torque to reach a value equal to M_{L}+0.5(M_{H}−M_{L}), and the time for the torque to reach M_{L}+0.9(M_{H}−M_{L}), (t′90). Results are reported in Tables 3, 9, and 11.

Physical Properties: Sheet samples were molded for 10 min on a Wabash MPI Model 76-1818-2TMAC press set to 177° C. and 75 tons (68 metric tons). Post-curing conditions are given in Tables 3, 5, 7, 9, and 11 below. Tensile, elongation, and modulus data were gathered from press cured and post cured samples cut at room temperature to Die D specifications in accordance with ASTM 412-06A.

Molded O-rings and Compression Set: O-rings (214, AMS AS568) were molded for 10 min on a Wabash MPI Model 76-1818-2TMAC press set to 177° C. and 50 tons (45 metric tons). The press cured O-rings were post cured at 250° C. for 16 h. The post cured O-rings were tested for compression set for 70 h at 200° C. in accordance with ASTM D 395-03 Method B and ASTM D1414-94 with a 25% deflection. Results are reported as percentages.

Trouser Tear: Trouser tear samples were evaluated in accordance with ISO34-1: 2015 method A.

Bonding evaluations: 10 g of the fluoropolymers outlined below were placed in contact with 10 g of the silicone into a 1 in. by 3 in. (2.54 cm×7.62 cm) rectangular mold. There was a 0.5 in. by 1.0 in. (1.27 cm by 2.54 cm) release liner placed between the layers at one end. The layers were then pressed together for 10 min on a Wabash MPI Model 76-1818-2TMAC press set to 325° F. (162.8° C.) and 74 tons (67 metric tons). The samples were then post cured for 3 h at 200° C. The samples were then evaluated for bonding by carrying out a 180 peel test at 12.0 in/min (30.5 cm/min) in a tensiometer from MTS Systems Corporation, Eden Prairie, Minn., following ASTM D413-76, type A.

Viscosity: Viscosity of Preparatory Examples 1 and 2 were measured on a Brookfield DV-II+Viscometer with the LV4 spindle.

### Preparatory Examples

### Preparatory Example 1 (PE-1), Vinyl SSQ

To 50 g vinyltrimethoxysilane (Oakwood Chemical, Estill, S.C.) was added 32 g deionized water. This was mixed using a mechanical stirrer before 0.5 g 5 wt% HCl solution was added, and the solution was heated at 65° C. for 6 h. To this was added 10 g Ethoxytrimethylsilane (Oakwood Chemical) and heated at 65° C. for 2 h. This was followed by cooling the mixture to ambient temperature and then quenching the reaction by adding ice water. Two layers formed and the bottom layer was decanted using a separatory funnel and then washed with 100 g cold water 3 times. The vinyl SSQ obtained was dried in a vacuum at 30° C. for 8 h to remove residual water. The viscosity of Preparative Example 1 was 2100 centipoise (cps).

### Preparatory Example 2 (PE-2), Allyl SSQ

Preparatory Example 2 was prepared using the method described for PE-1, with the exception that allyltrimethoxysilane (Oakwood Chemical) was used in place of vinyltrimethoxysilane. The viscosity of Preparative Example 1 was 890 centipoise (cps).

### Preparatory Example 3 (PE-3), Vinyl-Octadecyl SSQ

Preparatory Example 3 was prepared using the method described for PE-1, with the exception that a portion of the vinyltrimethoxysilane was replaced with n-octadecyltrimethoxysilane (Gelest) to give a final weight ratio of 77.8 (vinyltrimethoxysilane) to 22.2 (n-octadecyltrimethoxysilane). Preparative Example 3 was a waxy solid.

### Preparatory Example 4 (PE-4), Vinyl-Perfluorohexylethyl SSQ

Preparatory Example 4 was prepared using the method described for PE-1, with the exception that a portion of vinyl trimethoxysilane was replaced with 1H,1H,2H,2H-Perfluorooctyltrimethoxysilane (Oakwood Chemical) to give a final weight ratio of 80 (vinyl trimethoxysilane) to 20 (1H,1H,2H,2H-Perfluorooctyltrimethoxysilane).

Fluoropolymers, carbon black, SSQ or silane, TAIC, and peroxide, in amounts as indicated in Tables 2, 4, 8, and 10 were mixed on a 6 in (15.24 cm) open roll mill. For Silicone 1 and Silicone 2, the silicones indicated in Table 6 were used as received. For Silicone 3, the indicated silicone was banded on a 6 in (15.24 cm) open roll mill and the amount of vinyl SSQ indicated in Table 6 was added dropwise while cutting and folding silicone until it was incorporated completely. Milling continued for an additional 10 min and then the silicone was removed from the mill.

TABLE 2
Formulations for Vinyl SSQ and Allyl SSQ

| Material | CE-1 | EX-1 | EX-2 | EX-3 | EX-4 | EX-9 | EX-10 | EX-11 | EX-12 |
|---|---|---|---|---|---|---|---|---|---|
| FPO3820 | 100 | 100 | 100 | 100 | 100 | 100 | 100 | 100 | 100 |
| N990 | 30 | 30 | 30 | 30 | 30 | 30 | 30 | 30 | 30 |
| PE-1 | — | — | — | 3 | 3 | — | — | — | — |
| PE-2 | — | 3 | 3 | — | — | — | — | — | — |
| PE-3 | — | — | — | — | — | 3 | 3 | — | — |
| PE-4 | — | — | — | — | — | — | — | 3 | 3 |
| TAIC | 3 | — | 3 | — | 3 | — | 3 | — | 3 |
| DBPH-50 | 2 | 2 | 2 | 2 | 2 | 2 | 2 | 2 | 2 |

TABLE 3
Physical Properties Data

| | | | | | | | | |
|---|---|---|---|---|---|---|---|---|
| CE-1 | EX-1 | EX-2 | EX-3 | EX-4 | EX-9 | EX-10 | EX-11 | EX-12 |

Cure Rheology (177° C., 12 min)

| | | | | | | | | | |
|---|---|---|---|---|---|---|---|---|---|
| M_{L}, Minimum | 0.38 | 0.66 | 0.45 | 0.71 | 0.49 | 0.6 | 0.4 | 1.0 | 0.8 |
| Torque, dNm | | | | | | | | | |
| t′50, Time to | 0.71 | 1.62 | 1.36 | 0.71 | 0.74 | 0.8 | 0.7 | 0.8 | 0.8 |
| 50% cure - mm | | | | | | | | | |
| t′90, Time to | 1.20 | 5.55 | 3.69 | 2.15 | 1.48 | 3.1 | 1.5 | 2.3 | 1.5 |
| 90% cure - min | | | | | | | | | |
| M_{H}, Maximum | 29.75 | 19.28 | 41.29 | 22.93 | 44.07 | 20.6 | 46.7 | 26.7 | 43.1 |
| Torque, dNm | | | | | | | | | |

Tensile Properties, Post Cure at 232° C. (450° F.), 4 h

| | | | | | | | | | |
|---|---|---|---|---|---|---|---|---|---|
| Tensile, MPa | 22.6 | 17.6 | 20.6 | 16.3 | 22.8 | 12.7 | 18.4 | 15.3 | 22.1 |
| Elongation at | 200 | 310 | 214 | 332 | 237 | 389 | 212 | 307 | 224 |
| break, % | | | | | | | | | |
| 50% Modulus, | 2.4 | 2.3 | 3.3 | 2.4 | 3.7 | 2.3 | 3.8 | 2.4 | 3.5 |
| MPa | | | | | | | | | |
| 100% Modulus, | 7.3 | 4.1 | 7.3 | 4.3 | 8.2 | 3.4 | 7.7 | 4.6 | 8.1 |
| MPa | | | | | | | | | |
| Hardness, | 73 | 76 | 78 | 74 | 79 | 78 | 82 | 76 | 79 |
| Shore A | | | | | | | | | |

Compression Set 70 h at 200° C., 25% deflection

| | | | | | | | | | |
|---|---|---|---|---|---|---|---|---|---|
| Post Cure | 20 | 62 | 27 | 49 | 20 | 59 | 21 | 55 | 23 |

TABLE 4
Formulations for Vinyl SSQ loading study

| Material | CE-2 | EX-5 | EX-6 | EX-7 | EX-8 |
|---|---|---|---|---|---|
| FPO3620 | 100 | 100 | 100 | 100 | 100 |
| N990 | 30 | 30 | 30 | 30 | 30 |
| PE-1 | | 0.5 | 1 | 2 | 3 |
| TAIC | 0.5 | 0.5 | 0.5 | 0.5 | 0.5 |
| DBPH-50 | 2 | 2 | 2 | 2 | 2 |

TABLE 5
Tensile Data for Vinyl SSQ loading study

| | | | | |
|---|---|---|---|---|
| CE-2 | EX-5 | EX-6 | EX-7 | EX-8 |

Tensile Properties, Post Cure at 200° C. (392^{o} F.), 4 h

| | | | | | |
|---|---|---|---|---|---|
| Tensile, MPa | 15.8 | NM | 19.9 | 11.8 | 14.6 |
| Elongation at | 374 | NM | 339 | 254 | 335 |
| break, % | | | | | |
| 50% Modulus, | 1.3 | NM | 1.7 | 1.9 | 1.9 |
| MPa | | | | | |
| 100% | 2.0 | NM | 3.0 | 3.5 | 3.3 |
| Modulus, MPa | | | | | |
| Hardness, | NM | 68 | 69 | 69 | 64 |
| Shore A | | | | | |

Trouser Tear

| | | | | | |
|---|---|---|---|---|---|
| kN/m | 5.6 | NM | 6.6 | 6.5 | 8.5 |

NM = not measured

TABLE 6
Silicone formulation

| | Silicone 1 | Silicone 2 | Silicone 3 |
|---|---|---|---|
| SLM19045 | 100 | — | — |
| SLM19046 | — | 100 | 100 |
| PE-1 | — | — | 3 |

TABLE 7
Bonding of Fluoropolymer and Silicone

| | Tensile Properties, Post Cure at | | | | |
|---|---|---|---|---|---|
| | 200° C. (392^{o} F.), 3 h | | | | |
| | | CE-2 | EX-6 | EX-7 | EX-8 |
| Bond Strength, | Silicone 1 | 4.9 | NM | NM | 15.3 |
| lbf/in (Nm) | | (0.55) | | | (1.73) |
| Failure Mode | | AF | | | ST |
| | Silicone 2 | 4.2 | 8.3 | 13.7 | 19.1 |
| | | (0.48) | (0.93) | (1.55) | (2.16) |
| | | AF | AF | ST | ST |
| | Silicone 3 | 8.1 | NM | NM | 8.9 |
| | | (0.92) | | | (1.0) |
| | | ST | | | ST |

AF = adhesive failure
ST = silicone tear
NM = not measured

TABLE 8
Formulations for other silanes

| Material | CE-3 | CE-4 | CE-5 |
|---|---|---|---|
| FPO3820 | 100 | 100 | 100 |
| N990 | 30 | 30 | 30 |
| VMQ | 3 | — | — |
| Divinyl PDMS | — | 3 | — |
| Tetra Vinyl cyclic siloxane | — | — | 3 |
| DBPH-50 | 2 | 2 | 2 |

TABLE 9
Physical Properties Data

| | | |
|---|---|---|
| CE-3 | CE-4 | CE-5 |

Cure Rheology (177° C., 12 min)

| M_{L}, Minimum | 1.6 | 1.6 | 1.6 |
|---|---|---|---|
| Torque, dNm | | | |
| t′50, Time to | 2.0 | 1.1 | 1.9 |
| 50% cure - min | | | |
| t′90, Time to | 5.3 | 3.4 | 5.2 |
| 90% cure - min | | | |
| M_{H}, Maximum | 15.8 | 4.8 | 15.2 |
| Torque, dNm | | | |
| Tensile Properties, Post Cure at 232° C. | | | |
| (450^{o} F.), 4 h | | | |
| Tensile, MPa | 19.3 | 6.9 | 18.6 |
| Elongation at | 325 | 673 | 313 |
| break, % | | | |
| 50% Modulus, | 1.6 | 1.4 | 1.8 |
| MPa | | | |
| 100% Modulus, | 3.2 | 1.9 | 3.3 |
| MPa | | | |
| Hardness, Shore | 69 | 70 | 71 |
| A | | | |
| Compression Set 70 h at 200° C., 25% | | | |
| deflection | | | |
| Post Cure | 84 | 89 | 84 |

TABLE 10
Formulations for Examples 13 to 19

| Material | EX-13 | EX-14 | EX-15 | EX-16 | EX-17 | EX-18 | EX-19 |
|---|---|---|---|---|---|---|---|
| FPO3620 | 100 | — | — | — | — | — | — |
| FP3 | — | 100 | — | — | — | — | — |
| FP4 | — | — | 100 | — | — | — | — |
| FP5 | — | — | — | 100 | — | — | — |
| FP6 | — | — | — | — | 100 | — | — |
| FP7 | — | — | — | — | — | 100 | — |
| FP8 | — | — | — | — | — | — | 100 |
| N990 | 30 | 30 | 30 | 30 | 30 | 30 | 30 |
| PE-1 | 3 | 3 | 3 | 3 | 3 | 3 | 3 |
| BPO | 4 | — | — | 4 | — | — | — |
| DBPH-50 | — | 2 | 2 | — | 2 | 2 | 2 |

TABLE 11
Physical Properties Data

| | EX-13 | EX-14 | EX-15 | EX-16 | EX-17 | EX-18 | EX-19 |
|---|---|---|---|---|---|---|---|
| Cure rheology (Cure A: 177° C., | B | A | A | B | A | A | A |
| 12 mins) or (Cure B: 130° C., 12 | | | | | | | |
| mins) | | | | | | | |
| M_{L}, Minimum Torque, N m | 1.5 | 0.9 | 1.1 | 8.0 | 2.0 | 1.5 | 3.1 |
| M_{H}, Maximum Torque, N m | 21.2 | 34.6 | 13.7 | 14.2 | 7.2 | 19.3 | 10.7 |
| t′50, Time to 50% cure - minutes | 0.6 | 0.49 | 0.9 | 0.6 | 1.55 | 0.7 | 0.7 |
| t′90, Time to 90% cure - minutes | 1.1 | 1.02 | 2.4 | 1.7 | 6.15 | 1.7 | 1.7 |
| tan d M_{L} | 0.75 | 0.95 | 0.81 | 0.38 | 0.67 | 0.74 | 0.46 |
| tan d M_{H} | 0.078 | 0.03 | 0.171 | 0.195 | 0.274 | 0.111 | 0.177 |

Post Cure @ 232° C. (450° F.), 4 hours

| | | | | | | | |
|---|---|---|---|---|---|---|---|
| Tensile, MPa | 9.8 | 15.9 | 10.0 | 11.8 | 7.7 | 15.0 | 7.3 |
| Elongation at break, % | 398 | 174 | 259 | 352 | 491 | 413 | 372 |
| 50% Modulus, MPa | 1.6 | 3.1 | 1.5 | 1.8 | 1.9 | 1.6 | 1.3 |
| 100% Modulus, MPa | 2.5 | 7.6 | 3.4 | 2.9 | 3.5 | 2.7 | 2.1 |
| Hardness, Shore A | 63 | 68 | 63 | 69 | 68 | 67 | 60 |

Compression Set 70 hours @200° C., 25% deflection

| | | | | | | | |
|---|---|---|---|---|---|---|---|
| post cure | 52 | 34 | NM | 72 | 82 | 48 | 50 |

Various modifications and alterations of this disclosure may be made by those skilled the art without departing from the scope and spirit of this disclosure, and it should be understood that this invention is not to be unduly limited to the illustrative embodiments set forth herein.

1. A composition comprising:
a fluoropolymer; and
a branched silsesquioxane polymer comprising terminal —Si(R³)₃ groups and units represented by formula: 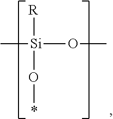
wherein
* represents a bond to another silicon atom in the branched silsesquioxane polymer;
each R is independently an organic group comprising an aliphatic carbon-carbon double bond; and
each R³ is independently a non-hydrolyzable group with the proviso that one R³ may be hydrogen.

2. The composition of claim 1, wherein the branched silsesquioxane polymer further comprises units represented by formula: 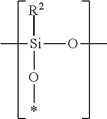
wherein.
* represents a bond to another silicon atom in the branched silsesquioxane polymer; and
each R² is independently hydrogen, alkyl, aryl, or alkylene at least one of interrupted or terminated by arylene or heterocyclylene, wherein alkyl and alkylene at least one of interrupted or terminated by arylene or heterocyclylene are unsubstituted or substituted with halogen and optionally interrupted by at least one catenated —O—, and wherein aryl, arylene, and heterocyclylene are unsubstituted or substituted by at least one alkyl, alkoxy, halogen, or combination thereof.

3. The composition of claim 1, wherein each R is independently represented by —Y—Z, wherein Y is a bond, alkylene, arylene, or alkylene at least one of interrupted or terminated by arylene, and wherein Z is —CH═CH₂, —O—CH═CH₂, —O—C(O)—CH═CH₂, —O—C(O)—C(CH₃)═CH₂, —NR′—C(O)—CH═CH₂, or —NR′—C(O)—C(CH₃)═CH₂, wherein R′ is hydrogen or alkyl having up to four carbon atoms, or wherein —Y—Z is —CH₂—CH═CH₂.

4. The composition of claim 1, wherein each R³ is independently alkyl having up to four carbon atoms.

5. The composition of claim 1, wherein the fluoropolymer is an amorphous, curable fluoropolymer.

6. The composition of claim 1, wherein the fluoropolymer comprises at least one of choro, bromo, iodo, or cyano cure sites.

7. The composition of claim 1, further comprising a peroxide initiator.

8. The composition of claim 1, further comprising at least one of tri(methyl)allyl isocyanurate, triallyl isocyanurate, tri(methyl)allyl cyanurate, poly-triallyl isocyanurate, xylylene-bis(diallyl isocyanurate), N,N′-m-phenylene bismaleimide, diallyl phthalate, tris(diallylamine)-s-triazine, triallyl phosphite, diallyl ether of glycerin, triallylphosphate, diallyl adipate, diallylmelamine, 1,2-polybutadiene, ethyleneglycol diacrylate, diethyleneglycol diacrylate, or CH₂═CH—R_{f1}—CH═CH₂, wherein R_{f1} is a perfluoroalkylene having from 1 to 8 carbon atoms.

9. An article comprising a first composition comprising a fluoropolymer in contact with a second composition comprising a silicone, wherein at least one of the first composition or second composition comprises a branched silsesquioxane polymer comprising terminal —Si(R³)₃ groups and units represented by formula: 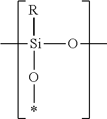
wherein
* represents a bond to another silicon atom in the branched silsesquioxane polymer;
each R is independently an organic group comprising an aliphatic carbon-carbon double bond; and
each R³ is independently a non-hydrolyzable group with the proviso that one R³ may be hydrogen.

10. The article of claim 9, wherein the branched silsesquioxane polymer further comprises units represented by formula: 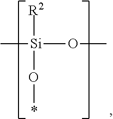
wherein.
* represents a bond to another silicon atom in the branched silsesquioxane polymer; and
each R² is independently hydrogen, alkyl, aryl, or alkylene at least one of interrupted or terminated by arylene or heterocyclylene, wherein alkyl and alkylene at least one of interrupted or terminated by arylene or heterocyclylene are unsubstituted or substituted with halogen and optionally interrupted by at least one catenated —O—, and wherein aryl, arylene, and heterocyclylene are unsubstituted or substituted by at least one alkyl, alkoxy, halogen, or combination thereof.

11. The article of claim 9 or 10, wherein each R is independently represented by —Y—Z, wherein Y is a bond, alkylene, arylene, or alkylene at least one of interrupted or terminated by arylene, and wherein Z is —CH═CH₂, —CH₂—CH═CH₂, —O—CH═CH₂, —O—C(O)—CH═CH₂, —O—C(O)—C(CH₃)═CH₂, —NR′—C(O)—CH═CH₂, or —NR′—C(O)—C(CH₃)═CH₂, wherein R′ is hydrogen or alkyl having up to four carbon atoms, or —Y—Z is —CH₂—CH═CH₂, and wherein each R³ is independently alkyl having up to four carbon atoms.

12. The article of claim 9, wherein the fluoropolymer is an amorphous, curable fluoropolymer.

13. The article of claim 9, wherein the fluoropolymer comprises at least one of choro, bromo, iodo, or cyano cure sites.

14. An article comprising a fluoropolymer crosslinked with a branched silsesquioxane polymer comprising terminal —Si(R³)₃ groups and units represented by formula: 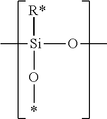
wherein
* represents a bond to another silicon atom in the branched silsesquioxane polymer;
each R* is independently an organic group comprising a carbon-carbon bond between the branched silsesquioxane polymer and the fluoropolymer or another R* group in the branched silsesquioxane polymer; and
each R³ is independently a non-hydrolyzable group with the proviso that one R³ may be hydrogen.

15. An article comprising a fluoropolymer in contact with a silicone, wherein at least one of the fluoropolymer or the silicone is crosslinked with a branched silsesquioxane polymer comprising terminal -Si(R³)3 groups and units represented by formula: 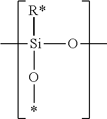
wherein
* represents a bond to another silicon atom in the branched silsesquioxane polymer;
each R* is independently an organic group comprising a carbon-carbon bond between the branched silsesquioxane polymer and the fluoropolymer, the silicone, or another R* group in the branched silsesquioxane polymer; and
each R³ is independently a non-hydrolyzable group with the proviso that one R³ may be hydrogen.

16. The composition of claim 1, further comprising a non-fluorinated, curable polymer.

17. The composition of claim 16, wherein the non-fluorinated, curable polymer is an ethylene-propylene-diene or a silicone.

18. The composition of claim 2, wherein each R² is independently unsubstituted alkyl or alkyl substituted by fluoro.

19. The composition of claim 1, wherein Y is a bond or —CH₂—, and wherein Z is —CH═CH₂.

20. The article of claim 9, wherein the silicone is a curable polydimethysiloxane.
